(19) United States
(12) Patent Application Publication
(10) Pub. No.: US 2026/0259515 A1
(43) Pub. Date: Sep. 3, 2026

(54) TONER SET AND MAGENTA TONER

(71) Applicant: ZEON CORPORATION, Tokyo (JP)

(72) Inventor: Kojiro Akazaki, Tokyo (JP)

(73) Assignee: ZEON CORPORATION, Tokyo (JP)

(21) Appl. No.: 19/157,514

(22) PCT Filed: Feb. 15, 2024
(86) PCT No.: PCT/JP2024/005128

§ 371 Date: Aug. 18, 2025

(30) Foreign Application Priority Data
Feb. 28, 2023 (JP) 2023-029720

(51) Int. Cl. G03G 9/08; G03G 9/087; G03G 9/09

(52) U.S. Cl. CPC G03G 9/0821; G03G 9/08782; G03G 9/08784; G03G 9/092

(57) ABSTRACT

A toner set which is configured to suppress peeling of the toner layer(s) of a full-color image thus formed and which is less likely to produce ultrafine particles during toner fixation. A toner set comprising color toners comprising at least a yellow toner, a magenta toner and a cyan toner, wherein each of the yellow, magenta and cyan toners comprises, as the softening agent, an ester wax having a molecular weight of from 600 to 3000, and wherein a loss tangent of the yellow toner at 100° C., a loss tangent of the magenta toner at 100° C. and a loss tangent of the cyan toner at 100° C. are all 0.840 or more, and the absolute values of the differences between the loss tangents of the toners at 100° C. are all 0.140 or less.

### TECHNICAL FIELD

The present disclosure relates to a toner set comprising a combination of toners for developing electrostatic images (hereinafter may be simply referred to as “toners”) which are used to develop an electrostatic latent image in, for example, electrophotography, electrostatic recording, and electrostatic printing. The present disclosure also relates to a magenta toner used in the toner set.

### BACKGROUND ART

In image forming devices such as an electrophotographic device, an electrostatic recording device and an electrostatic printing device, a method for forming a desired image by forming an electrostatic latent image on a photoconductor and developing the image with a toner for developing electrostatic images, is widely used. This method is applied to a copying machine, a printer, a facsimile machine, multifunctional printers thereof, and so on.

For example, in an electrophotographic device using electrophotography, generally, the surface of its photoconductor comprising a photoconductive material, is uniformly charged by various kinds of changing f methods; by a static charge distribution with laser beam irradiation, an electrostatic latent image having a static charge distribution which can form an image required to be reproduced or which can form a negative image corresponding to the required image, is formed on the photoconductor; the electrostatic latent image is developed with a toner to form a toner image; the toner image is transferred onto a recording medium such as print paper directly or through a transfer medium; and the transferred toner image is fixed by heating or the like, thereby obtaining a copy.

In the case of forming a full-color image with toners for developing electrostatic images, first, an original image required to be reproduced, is separated into the three primary color components of yellow (Y), magenta (M) and cyan (C), or the four color components of the three primary colors and black (K). Then, the electrostatic latent images of each of the color components are formed on different photoconductors and developed, thereby forming the primary color toner images of each of the color components. Then, the primary color toner images of each of the color components are aligned on and transferred onto a transfer receptive medium selected from a recording medium or a transfer medium, thereby forming a higher-order color toner image including a higher-order color (such as a secondary color and a tertiary color) which is created by overlapping the primary colors. When the higher-order color toner image is formed on a transfer medium, the image is transferred onto a recording medium. Then, the higher-order color toner image on the recording medium is fixed by heating or the like, thereby obtaining a full-color image including a higher-order color gradation area.

As a toner set which is superior in gradation and color reproducibility of an image including a higher-order color and which is superior in continuous printing durability, Patent Document 1 discloses a toner set comprising at least a yellow toner, a cyan toner and a magenta toner, wherein the internal friction angle of the initial color toner and the internal friction angle of another toner satisfy a specific relational formula. The internal friction angles of the toners serve as toner flowability indices.

As a toner configured to achieve an excellent balance between the releasability of a printing paper from a fixing member and the suppression of peeling of layers, Patent Document 2 discloses a toner containing a binder resin and a release agent, which is characterized in that the peak intensity ratio (I_{w}/I_{B}) of an absorbance I_{w} derived from the release agent to an absorbance Is derived from the binder resin, which is obtained by total reflection absorption infrared spectroscopy, and the adhesion of the toner are within specific ranges. In Patent Document 2, the peak intensity ratio I_{w}/I_{B} is found as an index defining the amount of the release agent present in a region extending to a depth of 0.4 μm from a printing surface of the toner.

### CITATION LIST

### Patent Documents

Patent Document 1: International Publication No. WO2021/172517
Patent Document 2: International Publication No. WO2018/181131

### SUMMARY

### Technical Problem

However, a full-color image formed by use of a conventional toner set is problematic in that peeling of overlapped toner layers of different colors is likely to occur, and ultrafine particles (UFP) are likely to be generated.

The first object of the present disclosure is to provide a toner set which is configured to suppress peeling of the toner layer(s) of a full-color image thus formed and which is less likely to produce ultrafine particles during toner fixation.

The second object of the present disclosure is to provide a magenta toner which is applicable to the toner set of the present disclosure, which is less likely to produce ultrafine particles during the fixation of the toner, and which has high image density.

### Solution to Problem

According to the present disclosure, the following toner set is provided.
[1] A toner set comprising color toners each comprising colored resin particles, which contain a binder resin, a colorant, a softening agent and a charge control agent, and an external additive,
wherein the color toners comprise at least a yellow toner, a magenta toner and a cyan toner;
wherein each of the yellow, magenta and cyan toners comprises, as the softening agent, an ester wax having a molecular weight of from 600 to 3000; and
wherein a loss tangent of the yellow toner at 100° C. (tanδ (Y, 100° C.)), a loss tangent of the magenta toner at 100° C. (tanδ (M, 100° C.)) and a loss tangent of the cyan toner at 100° C. (tanδ (C, 100° C.)), each of which is specified from a temperature dependence curve of the loss tangent (tanδ) of the toner obtained by dynamic viscoelasticity measurement at a measurement frequency of 24 Hz, are all 0.840 or more and satisfy the following formulae (I), (II) and (III):

$$\vert tan δ ( M , 100 ° C . ) - tan δ ( Y , 100 ° C . ) \vert \leq 0.14 \qquad ( I )$$

$$\vert tan δ ( M , 100 ° C . ) - tan δ ( C , 100 ° C . ) \vert \leq 0.14 \qquad ( II )$$

$$\vert tan δ ( Y , 100 ° C . ) - tan δ ( C , 100 ° C . ) \vert \leq 0.14 . \qquad ( III )$$

[2] The toner set according to [1], wherein the magenta toner comprises, as the charge control agent, copolymers A and B each comprising a functional group-containing monomer unit; a content of the functional group-containing monomer unit in the copolymer A is larger than a content of the functional group-containing monomer unit in the copolymer B; and the functional group contained in the copolymer A and the functional group contained in the copolymer B are the same and are quaternary ammonium groups or quaternary ammonium salt-containing groups.
[3] The toner set according to [1] or [2], wherein the magenta toner comprises, as the colorant, a quinacridone skeleton-containing pigment.
[4] The toner set according to [3], wherein the magenta toner further comprises, as the colorant, a quinacridone skeleton-free pigment.

According to the present disclosure, the following image forming method is provided.
[5] An image forming method using the toner set defined by any one of [1] to [4].

According to the present disclosure, the following magenta toner is provided.
[6] A magenta toner comprising colored resin particles, which contain a binder resin, a colorant, a softening agent and a charge control agent, and an external additive,
wherein the softening agent comprises an ester wax having a molecular weight of from 600 to 3000;
wherein the charge control agent comprises copolymers A and B each comprising a functional group-containing monomer unit; a content of the functional group-containing monomer unit in the copolymer A is larger than a content of the functional group-containing monomer unit in the copolymer B; and the functional group contained in the copolymer A and the functional group contained in the copolymer B are the same and are quaternary ammonium quaternary groups or ammonium salt-containing groups; and
wherein a loss tangent of the magenta toner at 100° C. (tanδ (M, 100° C.)), which is specified from a temperature dependence curve of the loss tangent (tanδ) of the toner obtained by dynamic viscoelasticity measurement at a measurement frequency of 24 Hz, is 0.840 or more.
[7] The magenta toner according to [6], wherein the colorant comprises a quinacridone skeleton-containing pigment.

### Advantageous Effects of Invention

The above-described toner set of the present disclosure can form a full-color image in which peeling of the toner layer(s) is suppressed, and it can suppress the production of the ultrafine particles during toner fixation.

The above-described magenta toner of the present disclosure is applicable to the toner set of the present disclosure; it can suppress the production of the ultrafine particles during the fixation of the toner; and it can form an image with high image density.

### BRIEF DESCRIPTION OF DRAWING

FIG. 1 A schematic view of an example of an image forming device applicable to image formation using the toner set of the present disclosure.

### DESCRIPTION OF EMBODIMENTS

### 1. Toner Set

The toner set of the present disclosure includes at least three color toners of a yellow toner, a cyan toner and a magenta toner. It may further include a different color toner. Each of the color toners contains colored resin particles, which contain a binder resin, a colorant, a softening agent and a charge control agent, an external additive.

Hereinafter, a method for producing the colored resin particles used in the present disclosure, the colored resin particles obtained by the production method, the external additive that is further contained in the color toners, the viscoelasticity of the toners of the toner set of the present disclosure, and an image forming method using the toner set of the present disclosure will be described in order.

### 1-1. Method for Producing Colored Resin Particles

In general, methods for producing colored resin particles are broadly classified into dry methods such as a pulverization method and wet methods such as an emulsion polymerization agglomeration method, a suspension polymerization method and a solution suspension method. The wet methods are preferable since a toner having excellent printing properties such as image reproducibility, can be easily obtained. Among the wet methods, polymerization methods such as the emulsion polymerization agglomeration method and the suspension polymerization method are preferable, since a toner having a relatively small particle size distribution in micron order can be easily obtained. Among the polymerization methods, the suspension polymerization method is more preferable.

The emulsion polymerization agglomeration method is a method for producing colored resin particles by polymerizing emulsified polymerizable monomers to obtain a resin microparticle emulsion, and aggregating the resulting resin microparticles with a colorant dispersion, etc. The solution suspension method is a method for producing colored resin particles by forming a solution into droplets in an aqueous medium, the solution containing toner components (such as a binder resin and a colorant) dissolved or dispersed in an organic solvent, and removing the organic solvent. Both methods can be carried out by known methods.

The colored resin particles used in the present disclosure can be produced by the wet methods or the dry methods. The suspension polymerization method is preferable among the wet methods. When the suspension polymerization method is employed, the colored resin particles are produced by the following steps.

### (A) Suspension Polymerization Method

### (A-1) Preparation Step of Polymerizable Monomer Composition

First, a polymerizable monomer, a colorant, a softening agent, a charge control agent and, as needed, another additive such as a molecular weight modifier are mixed to prepare a polymerizable monomer composition. For example, a media type disperser is used for mixing them in the preparation of the polymerizable monomer composition.

### [Polymerizable Monomer]

In the present disclosure, the polymerizable monomer means a monomer having a polymerizable functional group, and a binder resin is made by polymerization of the polymerizable monomer. It is preferable to use a monovinyl monomer as a main component of the polymerizable monomer.

As the monovinyl monomer, examples include, but are not limited to, styrene; styrene derivatives such as vinyltoluene and α-methylstyrene; acrylic acid and methacrylic acid; acrylic acid esters such as methyl acrylate, ethyl acrylate, propyl acrylate, butyl acrylate, 2-ethylhexyl acrylate and dimethylaminoethyl acrylate; methacrylic acid esters such as methyl methacrylate, ethyl methacrylate, propyl methacrylate, butyl methacrylate, 2-ethylhexyl methacrylate and dimethylaminoethyl methacrylate; nitrile compounds such as acrylonitrile and methacrylonitrile; amide compounds such as acrylamide and methacrylamide; and olefins such as ethylene, propylene and butylene. These monovinyl monomers may be used alone or in combination of two or more. Among them, styrene, the styrene derivatives, and the acrylic or methacrylic esters are preferably used as the monovinyl monomer.

To improve hot offset resistance and storage stability, an optional crosslinkable polymerizable monomer is preferably used in combination with the monovinyl monomer. The crosslinkable polymerizable monomer is a monomer containing two or more polymerizable functional groups.

As the crosslinkable polymerizable monomer, examples include, but are not limited to, aromatic divinyl compounds such as divinyl benzene, divinyl naphthalene and derivatives thereof; ester compounds such as ethylene glycol dimethacrylate and diethylene glycol dimethacrylate, in which two or more carboxylic acids containing a carbon-carbon double bond are esterified to an alcohol containing two or more hydroxyl groups; other divinyl compounds such as N, N-divinylaniline and divinyl ether; and compounds containing three or more vinyl groups. The crosslinkable polymerizable monomers may be used alone or in combination of two or more. Of them, an aromatic divinyl compound is preferably used as the crosslinkable polymerizable monomer, and divinylbenzene is particularly preferably used.

When the polymerizable monomer contains the crosslinkable polymerizable monomer, with respect to 100 parts by mass of the monovinyl monomer, the content of the crosslinkable polymerizable monomer is generally from 0.1 parts by mass to 5 parts by mass, preferably from 0.3 parts by mass to 2 parts by mass, and more preferably from 0.5 parts by mass to 1 part by mass.

It is preferable to use a macromonomer as a part of the polymerizable monomer, since a good balance between the storage stability and low temperature fixability of the toner is obtained. The macromonomer has a polymerizable carbon-carbon unsaturated double bond at the terminal of the molecular chain and is a reactive oligomer or polymer which usually has a number average molecular weight of from 1,000 to 30,000. As the macromonomer, examples include, but are not limited to, a styrene macromonomer, a styrene-acrylonitrile macromonomer, a polyacrylic ester macromonomer and a polymethacrylic ester macromonomer. Among them, at least one selected from the group consisting of a polyacrylic ester macromonomer or a polymethacrylic ester macromonomer is preferably used. As the acrylic ester used in the polyacrylic ester macromonomer, examples include the above-mentioned acrylic esters usable as the monovinyl monomer. As the methacrylic ester used in the polymethacrylic ester macromonomer, examples include the above-mentioned methacrylic esters usable as the monovinyl monomer. As the macromonomer, it is preferable to appropriately select and use such a macromonomer, that when the polymerizable monomer includes the macromonomer, the glass transition temperature (Tg) of the obtained binder resin is higher than the case where the polymerizable monomer does not include the macromonomer.

As the macromonomer, a commercially-available product may be used. As the commercially-available product of the macromonomer, examples include, but are not limited to, macromonomer series AA-6, AS-6, AN-6S, AB-6 and AW-6S manufactured by Toagosei Co., Ltd.

The macromonomers may be used alone or in combination of two or more.

When the polymerizable monomer includes the macromonomer, the content of the macromonomer is not particularly limited. The content of the macromonomer is preferably from 0.03 parts by mass to 5 parts by mass, more preferably from 0.05 parts by mass to 2 parts by mass, still more preferably from 0.1 parts by mass to 1.5 parts by mass, and even more preferably from 0.3 parts by mass to 1 part by mass, with respect to 100 parts by mass of the monovinyl monomer.

### [Colorant]

As the colorant, a colorant conventionally used in toners can be appropriately selected and used without particular limitation.

As the colorant used in the magenta toner, examples include, but are not limited to, magenta pigments such as condensed polycyclic pigments (e.g., quinacridone-based pigments) and azo-based pigments (e.g., monoazo pigments, disazo pigments and condensed azo-based pigments) and magenta dyes. More specifically, examples include, but are not limited to, C.I. Pigment Red 31, 48, 57:1, 58, 60, 63, 64, 68, 81, 83, 87, 88, 89, 90, 112, 114, 122, 123, 144, 146, 149, 150, 163, 170, 184, 185, 187, 202, 206, 207, 209, 237, 238, 251, 254, 255 and 269; C.I. Pigment Violet 19; C.I. Solvent Red 1, 3, 8, 23, 24, 25, 27, 30, 49, 81, 82, 83, 84, 100, 109 and 121; C.I. Disperse Red 9; C.I. Solvent Violet 8, 13, 14, 21 and 27; C.I. Disperse Violet 1; C.I. Basic Red 1, 2, 9, 12, 13, 14, 15, 17, 18, 22, 23, 24, 27, 29, 32, 34, 35, 36, 37, 38, 39 and 40; and C.I. Basic Violet 1, 3, 7, 10, 14, 15, 21, 25, 26, 27 and 28.

The magenta toner preferably comprises, as the colorant, a quinacridone skeleton-containing pigment (in the present disclosure, it may be referred to as “quinacridone-based pigment”). Accordingly, the toner thus obtained can provide a printed product with excellent saturation and image density, and the toner is likely to obtain the desired viscoelasticity. As the quinacridone-based pigment, for example, C. I. Pigment Red 122, 192, 202, 206, 207 or 282, C.I. Pigment Violet 19 or the like is preferably used.

Of them, the quinacridone-based pigment is preferably at least one selected from the group consisting of C. I. Pigment Red 122 and C.I. Pigment Violet 19. The quinacridone-based pigment is more preferably a combination of C.I. Pigment Red 122 and C.I. Pigment Violet 19, and it is particularly preferably a mixed crystal of C.I. Pigment Violet 19 and C.I. Pigment Red 122.

The mixed crystal of C.I. Pigment Violet 19 and C.I. Pigment Red 122 can be prepared, for example, by the method described in U.S. Pat. No. 3,160,510, in which the mixed crystal components are simultaneously recrystallized from sulfuric acid or another suitable solvent and, if necessary, treated with a solvent after salt grinding. The mixed crystal of C.I. Pigment Violet 19 and C.I. Pigment Red 122 can be also prepared, for example, by the method described in German Pat. No. 1217333, in which the substituted diaminoterephthalic acid mixture is treated with a solvent after cyclization.

When C.I. Pigment Violet 19 and C. I. Pigment Red 122 are contained in the magenta toner as the colorant, the mass ratio of C.I. Pigment Violet 19 to C.I. Pigment Red 122 used is preferably from 80:20 to 20:80, more preferably from 70:30 to 30:70, and still more preferably from 60:40 to 40:60.

The magenta toner preferably comprises, as the colorant, the quinacridone-based pigment a quinacridone skeleton-free pigment. Accordingly, the formation of coarse particles can be suppressed, and the toner is likely to obtain the desired viscoelasticity. As the quinacridone skeleton-free pigment, an azo-based pigment is preferably used from the viewpoint of the saturation and image density of the printed product and from the viewpoint of the viscoelasticity of the toner. The azo-based pigment is preferably a monoazo pigment, and more preferably a pigment represented by the following formula (1) or a pigment obtained by treating the pigment represented by the following formula (1) with a rosin acid metal salt. In the present disclosure, the pigment obtained by treating the pigment represented by the following formula (1) with the rosin acid metal salt, is referred to as “magenta pigment A”. That is, the magenta pigment A is a pigment obtained by surface-treating the pigment represented by the following formula (1) with the rosin acid metal salt. In the magenta toner, the azo-based pigment used in combination with the quinacridone-based pigment is particularly preferably the magenta pigment A.

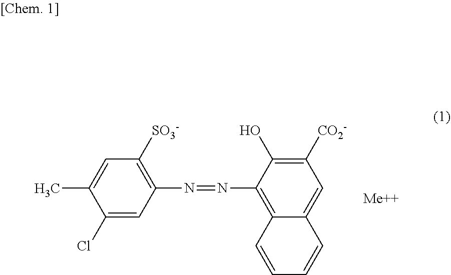

(where Me represents a divalent metal.)

The pigment represented by the formula (1) is classified as a so-called lake pigment. The lake pigment is an insoluble pigment obtained by the action of a metal salt on a dye. Since the lake pigment is inexpensive compared to other pigments, the use of the lake pigment is advantageous in that the cost of toner production can be reduced.

The magenta pigment A obtained by surface-treating the pigment represented by the formula (1) with the rosin acid metal salt, is effective in suppressing the formation of coarse particles during the production of the magenta toner, compared to a pigment not subjected to the surface treatment. Also, such a magenta toner can be obtained by the use of the magenta pigment A, that it provides vivid color and high reflection density even when the toner amount is small; it has an excellent balance between low temperature fixability and heat-resistant storage stability; and it has excellent printing durability.

As the pigment represented by the formula (1), examples include, but are not limited to, C.I. Pigment Red 48:1 (a pigment represented by the formula (1) where Me⁺⁺ is Ba⁺⁺), C.I. Pigment Red 48:2 (a pigment represented by the formula (1) where Me⁺⁺ is Ca⁺⁺), C.I. Pigment Red 48:3 (a pigment represented by the formula (1) where Me⁺⁺ is Sr⁺⁺), C.I. Pigment Red 48:4 (a pigment represented by the formula (1) where Me⁺⁺ is Mn⁺⁺), C.I. Pigment Red 48:5 (a pigment represented by the formula (1) where Me⁺⁺ is Mg⁺⁺) and C.I. Pigment Red 48:6 (a pigment represented by the formula (1) where Me⁺⁺ is Cd⁺⁺). Of them, C.I. Pigment Red 48:3 (CAS No. 15782 May 5) (a pigment represented by the formula (1) where Me⁺⁺ is Sr⁺⁺) is preferred. That is, the magenta pigment A is preferably a pigment which is classified as C.I. Pigment Red 48:3 and which is obtained by surface-treating C. I. Pigment Red 48:3 with the rosin acid metal salt.

The magenta pigment A may be a commercially-available product or a synthetic product. As the commercially-available product, examples include, but are not limited to, NO. 5500 ST-RED (product name, manufactured by: Daido Chemical Corporation, pigment classification: C.I. Pigment Red 48:3, the content of the rosin acid metal salt with respect to 100 parts by mass of the magenta pigment A: 5.0 parts by mass) and S-7014 RED (product name, manufactured by: Daido Chemical Corporation, pigment classification: C.I. Pigment Red 48:3, the content of the rosin acid metal salt with respect to 100 parts by mass of the magenta pigment A: 3.0 parts by mass).

In the case of synthesizing the magenta pigment A, for example, the dye used in the pigment represented by the formula (1) (the lake pigment) is synthesized by a coupling reaction using a coupler component containing the rosin acid metal salt, and the magenta pigment A is obtained by laking the obtained dye. Also, the magenta pigment A can be produced by, for example, bringing the pigment represented by the formula (1) (a raw material) into contact with the rosin acid metal salt.

As the rosin acid of the rosin acid metal salt, examples include, but are not limited to, well-known, commonly-used rosin acids such as abietic a an acid-based rosin acid, disproportionated rosin acid, a partially-hydrogenated rosin acid, a fully-hydrogenated rosin acid, a maleic acid-modified rosin acid, a fumaric acid-modified rosin acid and a polymerized rosin acid. As the rosin acid, a rosin acid having a low acid value is preferably used, such as a rosin acid having an acid value of 170 mgKOH/g or less, and preferably 100 mgKOH/g or less. The acid value of the magenta pigment A is decreased by using such a rosin acid having a low acid value. As a result, the formation of coarse particles can be suppressed.

The rosin acid metal salt is a salt consisting of a rosin acid and a divalent, trivalent or tetravalent metal, such as Ca salt, Ba salt, Sr salt, Al salt and Zn salt. As the rosin acid metal salt, a Sr salt of a rosin acid is preferably contained in view of, for example, a high effect of improving floodability in the toner production process.

With respect to 100 parts by mass of the magenta pigment A, the content of the rosin acid metal salt is generally from 1 part by mass to 7 parts by mass, preferably from 2 parts by mass to 6 parts by mass, and more preferably from 2.5 parts by mass to 5.5 parts by mass. When the content of the rosin acid metal salt is from 1 part by mass to 7 parts by mass, the release of the rosin acid metal salt is suppressed. As a result, inhibition of the toner production by the liberated rosin acid metal salt or a derivative thereof does not occur, and the toner containing less coarse particles is obtained. The content of the magenta pigment A can be obtained as the total content of the pigment represented by the formula (1) (a raw material) and the rosin acid metal salt (a surface modifier).

The acid value of the magenta pigment A is not particularly limited, and it is generally 3 mgKOH/g or less. From the viewpoint of suppressing the formation of coarse particles, the acid value is preferably 2.4 mgKOH/g or less, more preferably from 0.1 mgKOH/g to 2.0 mgKOH/g, and still more preferably from 0.4 mgKOH/g to 1.8 mgKOH/g. The acid value of the magenta pigment A can be controlled by the type and amount of the added rosin acid metal salt, for example.

In the present disclosure, the acid value is a value measured according to JIS K 0070 (standard methods for the analysis of oils and fats, established by JAPAN Industrial Standards Committee (JICS)).

When the magenta toner contains the magenta pigment A, with respect to 100 parts by mass of the binder resin, the content of the magenta pigment A is preferably from 1 part by mass to 10 parts by mass, more preferably from 1.5 parts by mass to 7 parts by mass, and still more preferably from 2 parts by mass to 5 parts by mass. When the content of the magenta pigment A is equal to or more than the lower limit value, such a magenta toner can be easily obtained, that even when the toner amount is small, it provides more vivid color than ever before, high reflection density, an excellent balance between low temperature fixability and heat-resistant storage stability, and excellent printing durability. When the content of the magenta pigment A is equal to or less than the upper limit value, inhibition of the toner production by an excess amount of the magenta pigment A does not occur, and the toner containing less coarse particles is likely to be obtained.

When the magenta toner contains, as the colorant, the quinacridone-based pigment in combination with the quinacridone skeleton-free pigment, the mass ratio between the quinacridone-based pigment and the quinacridone skeleton-free pigment is not particularly limited. From the viewpoint of obtaining more vivid color and higher reflection density, suppressing the formation of coarse particles and improving the printing durability and the low temperature fixability, with respect to their total amount of 100% by mass, that is, with respect to 100% by mass of the colorant contained in the magenta toner, the content of the quinacridone-based pigment is preferably from 25% by mass to 70% by mass, more preferably from 30% by mass to 60% by mass, and still more preferably from 35% by mass to 50% by mass.

As the quinacridone-based pigment, those described above may be used alone or in combination of two or more. As the quinacridone skeleton-free pigment, those described above may be used alone or in combination of two or more.

With respect to 100 parts by mass of the binder resin, the content of the colorant in the magenta toner is generally from 2 parts by mass to 10 parts by mass, preferably from 3 parts by mass to 9 parts by mass, and more preferably from 4 parts by mass to 8 parts by mass. When the content of the colorant is within the above range, the toner thus obtained shows higher reflection density and saturation, shows an improvement in the balance between the low temperature fixability and the heat-resistant storage stability, and obtains better printing durability.

In the present disclosure, 100 parts by mass of the binder resin corresponds to 100 parts by mass of the above-described polymerizable monomer. In the case of core-shell type colored resin particles, 100 parts by mass of the binder resin corresponds to 100 parts by mass of a polymerizable monomer used to obtain the core layer.

As the colorant used in the yellow toner, examples include, but are not limited to, yellow pigments such as azo-based pigments (e.g., monoazo pigments, disazo pigments and condensed azo-based pigments) and condensed polycyclic pigments, and yellow dyes. More specifically, examples include, but are not limited to, C.I. Pigment Yellow 3, 12, 13, 14, 15, 17, 62, 65, 73, 74, 83, 93, 97, 120, 138, 155, 180, 181, 185, 186, 213 and 214, and C.I. Solvent Yellow 98 and 162. From the viewpoint of the viscoelasticity of the toner and from the viewpoint of the saturation and image density of the printed product, preferred yellow colorants are disazo pigments such as C.I. Pigment Yellow 74, C.I. Pigment Yellow 120, C.I. Pigment Yellow 151, C.I. Pigment Yellow 155, C.I. Pigment Yellow 180, C.I. Pigment Yellow 185 and C.I. Pigment Yellow 213. Of them, C.I. Pigment Yellow 155 is particularly preferred.

As the colorant used in the cyan toner, examples include, but are not limited to, cyan pigments such as phthalocyanine pigments (e.g., copper phthalocyanine pigments and derivatives thereof) and anthraquinone pigments, and cyan dyes. More specifically, examples include, but are not limited to, C.I. Pigment Blue 2, 3, 6, 15, 15:1, 15:2, 15:3, 15:4, 16, 17:1 and 60, and C.I. Solvent Blue 70. From the viewpoint of the viscoelasticity of the toner and from the viewpoint of the saturation and image density of the printed product, preferred cyan colorants are copper phthalocyanine compounds (e.g., C.I. Pigment Blue 2, 3, 6, 15, 15:1, 15:2, 15:3, 15:4, 16, 17:1 and 60) and derivatives thereof. Of them, C.I. Pigment Blue 15:3 and 15:4 are particularly preferred.

As the colorant used in the black toner, examples include, but are not limited to, carbon black, titanium black and magnetic powder such as zinc-iron oxide and nickel-iron oxide.

From the viewpoint of image density and from the viewpoint of the viscoelasticity of the toner, the content of the colorant in each of the yellow, cyan and black toners is preferably from 1 part by mass to 10 parts by mass, and more preferably from 5 parts by mass to 9 parts by mass, with respect to 100 parts by mass of the binder resin.

In each color toner, the above-mentioned colorants can be used alone or in combination of two or more.

### [Charge Control Agent]

As the charge control agent, charge control agents that have been used in toners can be used without any particular limitation. Of the charge control agents, a charge control resin is preferably used. The charge control resin is preferred due to the following reasons: it has high compatibility with a binder resin; the charge control resin is colorless; and a toner that is stably charged during high-speed continuous color printing, can be obtained. Also, the charge control resin is preferred from the viewpoint of the viscoelasticity of the toner.

As the positively- or negatively-chargeable charge control resin, for example, a copolymer comprising a functional group-containing monomer unit (in the present disclosure, it may be simply referred to as “functional group-containing copolymer”) can be used.

As the positively-chargeable charge control resin, for example, a functional group-containing copolymer that contains a constitutional unit containing a functional group such as a pyridinium group, an amino group, a quaternary ammonium group and a quaternary ammonium salt-containing group, can be used. As the functional group-containing copolymer, examples include, but are not limited to, a polyamine resin, a quaternary ammonium group-containing copolymer and a quaternary ammonium salt group-containing copolymer.

As the negatively-chargeable charge control resin, for example, a functional group-containing copolymer that contains a constitutional unit containing a functional group such as a sulfonic acid group, a sulfonate-containing group, a carboxyl group and a carboxylic acid salt-containing group, can be used. As the functional group-containing copolymer, examples include, but are not limited to, a sulfonic acid group-containing copolymer, a sulfonic acid salt group-containing copolymer, a carboxyl group-containing copolymer and a carboxylic acid salt group-containing copolymer.

From the viewpoint of charge stability and print quality, the color toners included in the toner set of the present disclosure preferably contain the positively-chargeable charge control resin as the charge control agent.

From the viewpoint of improving the image density, the magenta toner included in the toner set of the present disclosure preferably comprises, as the charge control agent, copolymers A and B each comprising a functional group-containing monomer unit. The copolymers A and B are functional group-containing copolymers different in the content of the functional group-containing monomer unit (in the present disclosure, it may be simply referred to as “functional group amount”). The functional group amount of the copolymer A is larger than that of the copolymer B.

In the magenta toner, when the colored resin particles contain, as the charge control resin, the copolymer A having a relatively large functional group amount in combination with the copolymer B having a relatively small functional group amount, the dispersibility of the colorant can be improved while imparting the desired chargeability to the toner. As a result, the colorant can be contained at high concentration, and the image density can be improved, accordingly. When the copolymers A and B are used in combination as the charge control agent, due to the difference in the functional group amount, the toner is considered to have such a copolymer distribution, that the copolymer B is unevenly distributed on the relatively center side of the colored resin particles and the copolymer A is unevenly distributed on the more surface side of the colored resin particles. Since the copolymer A has a larger functional group amount than the copolymer B, it has a high charging effect and is unevenly distributed on the more surface side of the colored resin particles. Accordingly, the chargeability of the magenta toner is thought to be mainly subject to the influence of the copolymer A. Meanwhile, the copolymer B is thought to be highly effective in dispersing the colorant in the interior of the colored resin particles, while exerting a charging effect. It is presumed that by the action of such copolymers A and B, the desired chargeability is imparted to the toner, and the dispersibility of the colorant is improved.

From the viewpoint of imparting the desired chargeability to the toner, improving the dispersibility of the colorant, and imparting the desired viscoelasticity to the toner, the functional group amount of the copolymer A is preferably 5% by mass or more, and more preferably 6% by mass or more as the lower limit, and it is preferably 10% by mass or less, and more preferably 9% by mass or less as the upper limit.

From the viewpoint of imparting the desired chargeability to the toner, improving the dispersibility of the colorant, and imparting the desired viscoelasticity to the toner, the functional group amount of the copolymer B is preferably 0.4% by mass or more, and more preferably 0.5% by mass or more as the lower limit, and it is preferably less than 5% by mass, more preferably 4% by mass or less, and still more preferably 3% by mass or less as the upper limit.

From the viewpoint of imparting the desired chargeability to the toner, improving the dispersibility of the colorant, and imparting the desired viscoelasticity to the toner, the difference between the functional group amount of the copolymer A and that of the copolymer B (i.e., the functional group amount of the copolymer A—the functional group amount of the copolymer B) is preferably from 1% by mass to 9% by mass, more preferably from 2% by mass to 8% by mass, and still more preferably 3% by mass to 7% by mass.

The functional group contained in the copolymers A and B is preferably a functional group which can impart positively-chargeable property, such as a pyridinium group, an amino group, a quaternary ammonium group and a quaternary ammonium salt-containing group. From the viewpoint of imparting the desired chargeability to the toner, improving the dispersibility of the colorant, and imparting the desired viscoelasticity to the toner, the quaternary ammonium group and the quaternary ammonium salt-containing group are preferred, and the quaternary ammonium salt-containing group is more preferred.

The quaternary ammonium salt-containing group has an ionic structure represented by—NR₃⁺·X⁻. In the ionic structure, each R is independently a hydrogen atom or a substituent such as an alkyl group, and it is preferably a hydrogen atom or a linear, branched or cyclic alkyl group containing 1 to 6 carbon atoms. Also in the ionic structure, X⁻ is a halogen ion, an alkyl group in which one hydrogen atom is substituted with a halogen ion, or a hydrocarbon group which contains —SO₃⁻, —PO₃⁻ or —BO₃⁻ and in which at least one hydrogen atom is optionally substituted with a halogen atom. As the hydrocarbon group, examples include, but are not limited to, an alkyl group, an aromatic hydrocarbon group and a substituted aromatic hydrocarbon group. From the point of view that the charge amount of the toner is likely to be retained during continuous printing and a print failure is less likely to occur, X⁻ is preferably a hydrocarbon group which contains —SO₃⁻ and in which at least one hydrogen atom is optionally substituted with a halogen atom, more preferably an aromatic sulfonate anion which optionally contains at least one substituent selected from the group consisting of a halogen atom and a linear, branched or cyclic alkyl group containing 1 to 6 carbon atoms, and still more preferably a benzenesulfonate anion or a para-toluenesulfonate anion.

From the viewpoint of imparting the desired chargeability to the toner, improving the dispersibility of the colorant, and imparting the desired viscoelasticity to the toner, the functional group contained in the copolymer A and the functional group contained in the copolymer B preferably have the same structure, and they are preferably the same and are preferably quaternary ammonium groups or quaternary ammonium salt-containing groups.

Each of the copolymers A and B is preferably a styrene-acrylic copolymer, from the viewpoint of compatibility with a polymerizable monomer and from the viewpoint of the viscoelasticity of the toner. The styrene-acrylic copolymer may be a copolymer of an aromatic vinyl hydrocarbon monomer and a (meth)acrylate monomer.

As the copolymers A and B, a copolymer containing the functional group-containing monomer unit, an aromatic vinyl monomer unit, and a (meth)acrylate monomer unit is more preferred. The aromatic vinyl monomer unit and (meth)acrylate monomer unit used herein do not contain a functional group which can impart chargeability. Since such a copolymer has excellent compatibility with the binder resin, the charge amount of the toner is likely to be uniform.

In the present disclosure, (meth)acrylate means each of acrylate and methacrylate, and (meth)acryl means each of acryl and methacryl.

The copolymers A and B are preferably soluble in the aromatic vinyl monomer, from the viewpoint of dispersibility into the polymerizable monomer composition.

Each of the copolymers A and B may be, for example, a copolymer obtained by copolymerization of a monomer containing a functional group and another monomer which is copolymerizable with this, or it may be a copolymer obtained by polymerizing a monomer not containing a functional group and then introducing a functional group therein by modification treatment.

The copolymer containing the aromatic vinyl monomer unit, the (meth)acrylate monomer unit, and the monomer unit containing the quaternary ammonium salt-containing group, which is preferably used as the copolymers A and B, is not particularly limited. For example, it can be obtained by any of the following methods.

The polymerization method is not particularly limited. For example, a known polymerization method such as emulsion polymerization, dispersion polymerization, suspension polymerization and solution polymerization can be employed.
(i) A method in which an aromatic vinyl monomer, a (meth)acrylate monomer and an N, N-disubstituted aminoalkyl (meth)acrylate monomer are copolymerized in the presence of a polymerization initiator, followed by quaternizing the amino group with a quaternizing agent such as a halogenated organic compound and an acid ester compound.
(ii) A method in which an aromatic vinyl monomer, a (meth)acrylate monomer and a monomer in which N, N-disubstituted aminoalkyl (meth)acrylate monomer is made into a quaternary ammonium salt using a quaternizing agent such as a halogenated organic compound and an acid ester compound, are copolymerized in the presence of a polymerization initiator.

As the aromatic vinyl monomer, examples include, but are not limited to, styrene, α-methylstyrene, 2-methylstyrene, 3-methylstyrene, 4-methylstyrene, 2-ethylstyrene, 3-ethylstyrene, 4-ethylstyrene, 2-propylstyrene, 3-propylstyrene, 4-propylstyrene, 2-isopropylstyrene, 3-isopropylstyrene, 4-isopropylstyrene, 2,4-diisopropylstyrene, 2,4-dimethylstyrene, 4-butylstyrene, 4-t-butylstyrene, 5-t-butyl-2-methylstyrene, 2-chlorostyrene, 3-chlorostyrene, 4-chlorostyrene, 2-methyl-α-methylstyrene, 3-methyl-α-methylstyrene, 4-methyl-α-methylstyrene, 4-bromostyrene, 2-methyl-4,6-dichlorostyrene, 2,4-dibromostyrene and vinylnaphthalene. Of them, styrene and α-methylstyrene are preferred. These aromatic vinyl monomers may be used alone or in combination of two or more.

As the (meth)acrylate monomer, for example, an alkyl (meth)acrylate monomer optionally containing a hydroxyl group is preferably used. As the alkyl (meth)acrylate monomer optionally containing a hydroxyl group, examples include, but are not limited to, methyl (meth)acrylate, ethyl (meth)acrylate, propyl (meth)acrylate, isopropyl (meth)acrylate, n-butyl (meth)acrylate, isobutyl (meth)acrylate, n-amyl (meth)acrylate, isoamyl (meth)acrylate, n-hexyl (meth)acrylate, 2-ethylhexyl (meth)acrylate, hydroxypropyl (meth)acrylate and dodecyl (meth)acrylate. They may be used alone or in combination of two or more. In the alkyl (meth)acrylate monomer, the number of the carbon atoms of the alkyl group is not particularly limited. The alkyl group preferably contains 1 to 12 carbon atoms, more preferably 1 to 8 carbon atoms, and still more preferably 1 to 6 carbon atoms. Besides, an alkyl (meth)acrylate monomer containing no substituent is particularly preferred.

As the N, N-disubstituted aminoalkyl (meth)acrylate monomer, examples include, but are not limited to, dimethylaminomethyl (meth)acrylate, diethylaminomethyl (meth)acrylate, dipropylaminomethyl (meth)acrylate, diisopropylaminomethyl (meth)acrylate, ethylmethylaminomethyl (meth)acrylate, methylpropylaminomethyl (meth)acrylate, dimethylamino-1-ethyl (meth)acrylate, diethylamino-1-ethyl (meth)acrylate and dipropylamino-1-ethyl (meth)acrylate. They may be used alone or in combination of two or more. In the N, N-disubstituted aminoalkyl (meth)acrylate monomer, the number of the carbon atoms of the alkyl group is not particularly limited. The alkyl group preferably contains 1 to 3 carbon atoms.

As the halogenated organic compound used as the quaternizing agent, examples include, but are not limited to, a linear, branched or cyclic alkyl halide containing 1 to 6 carbon atoms, such as chloromethane, dichloromethane and trichloromethane, and an aromatic halide such as chlorobenzene, 4-chlorotoluene and 1-chloronaphthalene.

As the acid ester compound used as the quaternizing agent, examples include, but are not limited to, an alkyl sulfonic acid alkyl ester such as methyl methanesulfonate and ethyl methanesulfonate; a benzenesulfonic acid alkyl ester such as methyl benzenesulfonate; a p-toluenesulfonic acid alkyl ester such as methyl p-toluenesulfonate; a phosphoric ester such as trimethyl phosphate; and a boric acid ester such as trimethoxyborne.

These quaternizing agents may be used alone or in combination of two or more.

The monomer unit containing the quaternary ammonium salt-containing group, which is contained in the copolymers A and B, is preferably a constitutional unit represented by the following formula [I]:

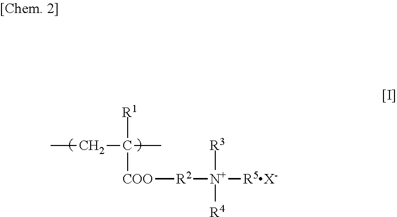

(where R¹ is a hydrogen atom or a methyl group; R² is a linear or branched alkylene group containing 1 to 3 carbon atoms, in which at least one hydrogen atom is optionally substituted with a halogen atom; each of R³ to R⁵ is independently a hydrogen atom or a linear, branched or cyclic alkyl group containing 1 to 6 carbon atoms; and X⁻ is a halogen ion, or a benzene or naphthalene which contains —SO₃⁻, —PO₃⁻ or —BO₃⁻ and which optionally contains at least one substituent selected from the group consisting of a halogen atom and a linear, branched or cyclic alkyl group containing 1 to 6 carbon atoms.)

As described above, X⁻ is a halogen ion or a benzene or naphthalene which contains —SO₃⁻, —PO₃⁻ or —BO₃⁻ and which optionally contains at least one substituent selected from the group consisting of a halogen atom and a linear, branched or cyclic alkyl group containing 1 to 6 carbon atoms. From the point of view that the charge amount of the toner is likely to be retained during continuous printing and a print failure is less likely to occur, X⁻ is more preferably the above-described aromatic sulfonate anion which optionally contains the substituent. As the aromatic sulfonate anion, examples include, but are not limited to, benzenesulfonate anion and para-toluenesulfonate anion.

As the constitutional unit represented by the formula [I], examples include, but are not limited to, a constitutional unit corresponding to a monomer containing a quaternary ammonium salt-containing group, such as N, N-diethyl-N-methyl-2-(methacryloyloxy)ethylammonium chloride, 2-(methacryloyloxy)ethyltrimethylammonium chloride (DMC: dimethylaminoethyl methacrylate methyl chloride), 2-(methacryloyloxy)-N-benzyl-N, N-dimethylethaneammonium chloride (DML: dimethylaminoethyl methacrylate benzyl chloride), N, N-diethyl-N-methyl-2-(methacryloyloxy)ethylammonium p-toluenesulfonate, 2-(methacryloyloxy)ethyl trimethylammonium p-toluenesulfonate, and 2-(methacryloyloxy)-N-benzyl-N, N-dimethylethaneammonium p-toluenesulfonate. Of them, a constitutional unit corresponding to N, N-diethyl-N-methyl-2-(methacryloyloxy)ethylammonium p-toluenesulfonate is preferred.

In the copolymers A and B, the copolymerization ratio between the aromatic vinyl monomer and the (meth)acrylate monomer is not particularly limited. From the viewpoint of solubility into the polymerizable monomer and dispersibility into the binder resin, the mass ratio of the (meth)acrylate monomer unit to the aromatic vinyl monomer unit (the (meth)acrylate monomer unit/the aromatic vinyl monomer unit) is preferably from 0.05 to 0.35, more preferably from 0.10 to 0.30, and still more preferably from 0.15 to 0.25.

From the viewpoint of imparting the desired chargeability to the toner, improving the dispersibility of the colorant, and imparting the desired viscoelasticity to the toner, the magenta toner preferably contains the copolymers A and B as the charge control agent, and each of the copolymers A and B is preferably composed of copolymers having the same monomer unit composition. The copolymers having the same monomer unit composition mean that the type and copolymerization ratio of the monomers used for the synthesis of the copolymers are the same. That is, the magenta toner preferably contains, as the charge control agent, the copolymer A of only one kind and the copolymer B of only one kind.

The glass transition temperature (Tg) of the copolymers A and B is not particularly limited. It is preferably within a range of 50° C. or more and 110° C. or less, and more preferably within a range of 60° C. or more and 100° C. or less. When the glass transition temperature (Tg) of the copolymers A and B is within the above range, the toner having preferred viscoelasticity can be easily obtained, and the storage stability of the toner can be improved. It is presumed that, since the copolymers A and B are likely to be localized near the surface of each colorant resin particle and can function as the shell, when the Tg of the functional group-containing copolymer is within the above range, the storage stability of the toner is improved due to the sufficiently high Tg.

In the present disclosure, the glass transition temperature (Tg) of the charge control resin can be obtained according to ASTM D3418-82, for example. More specifically, using a differential scanning calorimeter (SSC5200 manufactured by Seiko Instruments & Electronics Ltd.) or the like, the temperature of a sample is increased at a temperature increase rate of 10° C./min, thereby obtaining a DSC curve; and the temperature indicating the maximum endothermic peak in the DSC curve can be used as the glass transition temperature.

The weight average molecular weight (Mw) of the copolymers A and B is not particularly limited, and it is preferably in a range of 5000 or more and 30000 or less, and more preferably in a range of from 10000 or more and 25000 or less. When the weight average molecular weight (Mw) is equal to or more than the lower limit value, a decrease in the storage stability or printing durability can be suppressed. When the weight average molecular weight (Mw) is equal to or less than the upper limit value, a decrease in the fixability can be suppressed. In addition, when the weight average molecular weight (Mw) is within the above range, the copolymers A and B can be appropriately dispersed in the colored resin particles, and the toner having a charge amount that is stable over time, is easily obtained, accordingly.

In the present disclosure, the weight average molecular weight (Mw) is a polystyrene equivalent measured by gel permeation chromatography (GPC) using tetrahydrofuran (THF).

The content of the copolymer A in the magenta toner is not particularly limited. From the viewpoint of imparting the desired chargeability to the toner, improving the dispersibility of the colorant, and imparting the desired viscoelasticity to the toner, with respect to 100 parts by mass of the binder resin, the content of the copolymer A is preferably 0.5 parts by mass or more, more preferably 0.8 parts by mass or more, and still more preferably 1.0 part by mass or more as the lower limit, and it is preferably 10.0 parts by mass or less, more preferably 5.0 parts by mass or less, still more preferably 3.0 parts by mass or less, and even more preferably 2.0 parts by mass or less as the upper limit.

The content of the copolymer B in the magenta toner is not particularly limited. From the viewpoint of imparting the desired chargeability to the toner, improving the dispersibility of the colorant, and imparting the desired viscoelasticity to the toner, with respect to 100 parts by mass of the binder resin, the content of the copolymer B is preferably 0.1 parts by mass or more, more preferably 0.5 parts by mass or more, still more preferably 0.6 parts by mass or more, and even more preferably 0.8 parts by mass or more as the lower limit, and it is preferably 10.0 parts by mass or less, more preferably 3.0 parts by mass or less, still more preferably 2.0 parts by mass or less, and even more preferably 1.0 part by mass or less as the upper limit.

The ratio of the content of the copolymer A to the content of the copolymer B (i.e., the content of the copolymer A/the content of the copolymer B) is not particularly limited. From the viewpoint of imparting the desired chargeability to the toner, improving the dispersibility of the colorant, improving the heat resistance of the toner and imparting the desired viscoelasticity to the toner, the ratio is preferably 0.5 or more, more preferably 0.8 or more, still more preferably 1.0 or more, and even more preferably 1.5 or more as the lower limit, and it is preferably 15 or less, more preferably 10 or less, still more preferably 5 or less, and even more preferably 3 or less as the upper limit. When the ratio is equal to or more than the lower limit value, the toner quality can be easily controlled. When the ratio is equal to or less than the upper limit value, especially, the dispersibility of the colorant is improved. Accordingly, the image density can be easily improved.

In the magenta toner, the total content of the copolymers A and B is not particularly limited. From the viewpoint of imparting the desired chargeability to the toner and improving the dispersibility of the colorant and from the viewpoint of the viscoelasticity of the toner, with respect to 100 parts by mass of the binder resin, the total content of the copolymers A and B is preferably 0.6 parts by mass or more, more preferably 1 part by mass or more, and still more preferably 2 parts by mass or more as the lower limit, and it is preferably 30 parts by mass or less, more preferably 25 parts by mass or less, still more preferably 20 parts by mass or less, even more preferably 10 parts by mass or less, and particularly preferably 5 parts by mass or less as the upper limit.

The magenta toner may further contain a charge control agent which is different from the copolymer A or B, to the extent that does not impair the effects of the present disclosure. In this case, since the effects of the present disclosure are easily obtained, in 100% by mass of the charge control agent, the content of the copolymers A and B is preferably 90% by mass or more, more preferably 95% by mass or more, and still more preferably 99% by mass or more.

As the charge control resin contained in the color toners other than the magenta toner, from the viewpoint of imparting the desired chargeability and the desired viscoelasticity to the toner, a functional group-containing copolymer having a functional group amount of from 0.4% by mass to 10% by mass is preferably used. The functional group amount of the functional group-containing copolymer is preferably 3% by mass or more, more preferably 5% by mass or more, and still more preferably 6% by mass or more as the lower limit, and it is preferably 10% by mass or less, and more preferably 9% by mass or less as the upper limit.

As for the functional group-containing copolymer contained in the color toners other than the magenta toner, the descriptions of the type of the functional group, the type of the monomer used for the synthesis of the copolymer, the mass ratio of the (meth)acrylate monomer unit to the aromatic vinyl monomer unit, the glass transition temperature, and the weight average molecular weight Mw are explained in the same way as those of the functional group-containing copolymers contained in the magenta toner, that is, the copolymers A and B.

Each of the color toners included in the toner set of the present disclosure may further contain, as the charge control agent, a charge control compound having a relatively low molecular weight.

As the positively-chargeable charge control compound, examples include, but are not limited to, a nigrosine dye, a quaternary ammonium salt, a triaminotriphenylmethane compound and an imidazole compound.

As the negatively-chargeable charge control compound, examples include, but are not limited to, an azo dye containing a metal such as Cr, Co, Al and Fe, a salicylic acid metal compound and an alkyl salicylic acid metal compound.

In each of the color toners included in the toner set of the present disclosure, with respect to 100 parts by mass of the binder resin, the content of the charge control agent is preferably 0.01 parts by mass or more and 15 parts by mass or less, more preferably 0.1 parts by mass or more and 8 parts by mass or less, and still more preferably 0.5 parts by mass or more and 5 parts by mass or less. In the magenta toner, the content of the charge control agent is particularly preferably 1 part by mass or more and 5 parts by mass or less. In the color toners other than the magenta toner, the content of the charge control agent is particularly preferably 0.5 parts by mass or more and 1 part by mass or less. When the content of the charge control agent is equal to or more than the lower limit value, fogging can be suppressed. When the content is equal to or less than the upper limit value, printing stains can be suppressed. By controlling the content of the charge control agent, the viscoelasticity of the toner can be controlled.

In 100% by mass of the charge control agent contained in the color toners, the content of the charge control resin is preferably 90% by mass or more, more preferably 95% by mass or more, and still more preferably 99% by mass or more.

The charge control agents may be used alone or in combination of two or more.

### [Polar Resin]

The polymerizable monomer composition may contain a polar resin. Accordingly, the particle diameter of the colored resin particles can be easily controlled, and the production of coarse particles can be easily suppressed.

In the present disclosure, the polar resin is selected from the group consisting of polymers each containing a repeating unit including a heteroatom. As the polar resin, examples include, but are not limited to, an acrylic resin, a polyester resin, and a vinyl resin containing a heteroatom.

The polar resin may be a homopolymer or copolymer of a heteroatom-containing monomer, or it may be a copolymer of a heteroatom-containing monomer and a heteroatom-free monomer. When the polar resin is a copolymer of a heteroatom-containing monomer and a heteroatom-free monomer, in 100% by mass of all repeating units constituting the copolymer, the proportion of the heteroatom-containing monomer unit is preferably 50% by mass or more, more preferably 70% by mass or more, and still more preferably 90% by mass or more, since the particle diameter of the colored resin particles can be easily controlled, and the production of coarse particles can be easily suppressed.

As the heteroatom-containing monomer used in the polar resin, examples include, but are not limited to, a (meth)acryloyl group-containing monomer, that is, a (meth)acrylic monovinyl monomer such as an alkyl (meth)acrylate (e.g., methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, tert-butyl (meth)acrylate, n-pentyl (meth)acrylate, sec-pentyl (meth)acrylate, isopentyl (meth)acrylate, neopentyl (meth)acrylate, n-hexyl (meth)acrylate, isohexyl (meth)acrylate, neohexyl (meth)acrylate, sec-hexyl (meth)acrylate, tert-hexyl (meth)acrylate, 2-ethylhexyl (meth)acrylate, lauryl (meth)acrylate), a (meth)acrylic acid ester (e.g., 2-hydroxyethyl (meth)acrylate, 2-hydroxypropyl (meth)acrylate, 4-hydroxybutyl (meth)acrylate, methoxypolyethylene glycol (meth)acrylate, dimethylaminoethyl (meth)acrylate, diethylaminoethyl (meth)acrylate, glycidyl (meth)acrylate, 4-hydroxybutyl acrylate glycidyl ether) and (meth)acrylic acid; an aromatic vinyl monomer containing a heteroatom, such as halogenated styrene and styrene sulfonate; a carboxylic acid vinyl ester monomer such as vinyl acetate; a vinyl halide monomer such as vinyl chloride; a vinylidene halide monomer such as vinylidene chloride; a vinylpyridine monomer; a carboxyl group-containing monomer such as an ethylenically unsaturated carboxylic acid monomer (e.g., crotonic acid, cinnamic acid, itaconic acid, fumaric acid, maleic acid, butene tricarboxylic acid); and an epoxy group-containing monomer such as allyl glycidyl ether. These heteroatom-containing monomers may be used alone or in combination of two or more.

In the polar resin used in the positively-chargeable toner, the copolymerization ratio of the monomer containing the functional group which can impart positively-chargeable property and which is selected from the group consisting of a pyridinium group, an amino group, a quaternary ammonium group and a quaternary ammonium salt-containing group, is preferably 0.1% by mass or less. In the polar resin used in the negatively-chargeable toner, the copolymerization ratio of the monomer containing the functional group which can impart negatively-chargeable property and which is selected from the group consisting of a sulfonic acid group, a sulfonic acid salt-containing group, a carboxyl group and a carboxylic acid salt-containing group, is preferably 0.1% by mass or less. Accordingly, the charge stability of the toner can be improved, and the effect of suppressing the production of coarse particles is improved.

As the heteroatom-free monomer used in the polar resin, examples include, but are not limited to, a heteroatom-free, aromatic vinyl monomer such as styrene, vinyltoluene, α-methylstyrene and p-methylstyrene; a monoolefin monomer such as ethylene, propylene and butylene; and a diene monomer such as butadiene and isoprene. These heteroatom-free monomers may be used alone or in combination of two or more.

As the polar resin, such a heteroatom-containing monomer is preferred, that contains at least one kind of polar group-containing monomer unit which contains at least one kind of polar group selected from the group consisting of a carboxyl group, a hydroxyl group, a sulfonic acid group, an amino group, a polyoxyethylene group and an epoxy group, from the point of view that the particle diameter of the colored resin particles can be easily controlled, and the production of coarse particles can be easily suppressed. The polar group is preferably at least one selected from the group consisting of a carboxyl group and a hydroxyl group.

As the polar group-containing monomer, examples include, but are not limited to, the following: a carboxyl group-containing monomer such as an ethylenically unsaturated carboxylic acid monomer (e.g., acrylic acid, methacrylic acid, crotonic acid, cinnamic acid, itaconic acid, fumaric acid, maleic acid, butene tricarboxylic acid); a hydroxyl group-containing monomer such as 2-hydroxyethyl (meth)acrylate, 2-hydroxypropyl (meth)acrylate and 4-hydroxybutyl (meth)acrylate; a sulfonic acid group-containing monomer such as styrene sulfonate; an amino group-containing monomer such as dimethylaminoethyl (meth)acrylate and diethylaminoethyl (meth)acrylate; a polyoxyethylene group-containing monomer such as methoxypolyethylene glycol (meth)acrylate; and an epoxy group-containing monomer such as glycidyl (meth)acrylate, allyl glycidyl ether and 4-hydroxybutyl acrylate glycidyl ether. These polar group-containing monomers may be used alone or in combination of two or more.

When the polar resin contains the polar group-containing monomer unit, the polar group is preferably disposed at the terminal of the main chain or a side chain, or they are preferably bound to the main chain or a side chain in a pendant shape, from the point of view that the polar resin can be easily disposed at the surface of the droplets of the polymerizable monomer composition; the particle diameter of the colored resin particles can be easily controlled; and the production of coarse particles can be easily suppressed.

When the polar resin does not contain the polar group-containing monomer unit, the heteroatom-containing monomer unit contained in the polar resin preferably contains a monomer unit derived from an alkyl (meth)acrylate, from the point of view that high h compatibility with the polymerizable monomer is obtained; the particle diameter of the colored resin particles can be easily controlled; and the production of coarse particles can be easily suppressed. Especially from the viewpoint of high polarity, the heteroatom-containing monomer unit more preferably contains a monomer unit derived from an alkyl (meth)acrylate in which the number of the carbon atoms of the alkyl group is 3 or less, still more preferably a monomer unit derived from at least one selected from the group consisting of methyl (meth)acrylate and ethyl (meth)acrylate, and even more preferably a monomer unit derived from methyl (meth)acrylate.

The polar resin used in the positively-chargeable toner is preferably a copolymer of at least one selected from the group consisting of an acrylic ester and a methacrylic ester and at least one selected from the group consisting of acrylic acid and methacrylic acid, and more preferably a copolymer of an acrylic ester, a methacrylic ester and acrylic acid, from the point of view that high compatibility with the polymerizable monomer is obtained; the particle diameter of the colored resin particles can be easily controlled; and the production of coarse particles can be easily suppressed. In the present disclosure, such a polymer of (meth)acrylic acid ester and (meth)acrylic acid may be referred to as a “acrylic copolymer”.

In the acrylic copolymer, as the (meth)acrylic acid ester, examples include, but are not limited to, those exemplified above as the (meth)acrylic acid ester used in the heteroatom-containing monomer. In the acrylic copolymer, the (meth)acrylic acid ester may be a (meth)acrylic acid ester containing the polar group, or it may be a (meth)acrylic acid ester not containing the polar group. The (meth)acrylic acid ester is preferably a (meth)acrylic acid ester not containing the polar group, and it is more preferably an alkyl (meth)acrylate. The acrylic ester used in the acrylic copolymer is preferably at least one selected from the group consisting of ethyl acrylate, n-propyl acrylate, isopropyl acrylate and n-butyl acrylate, and it is more preferably at least one selected from the group consisting of ethyl acrylate and n-butyl methacrylate. The methacrylic ester used in the acrylic copolymer is preferably at least one selected from the group consisting of methyl methacrylate, n-propyl methacrylate, isopropyl methacrylate and n-butyl methacrylate, and it is more preferably methyl methacrylate.

In the acrylic copolymer, the proportion of the (meth)acrylic acid with respect to the total amount (100% by mass) of the (meth)acrylic acid ester and (meth)acrylic acid used for the synthesis of the acrylic copolymer, is preferably from 0.05% by mass to 1% by mass, more preferably from 0.1% by mass to 0.6% by mass, and still more preferably from 0.3% by mass to 0.5% by mass, from the point of view that the compatibility with the polymerizable monomer is high; the particle diameter of the colored resin particles can be easily controlled; and the production of coarse particles can be easily suppressed.

The acrylic copolymer is preferably a copolymer of monomers which contain 50.0% by mass or more of methyl methacrylate with respect to the total mass (100% by mass) of the monomers used for the synthesis of the copolymer, from the point of view that the compatibility with the polymerizable monomer is high; the particle diameter of the colored resin particles can be easily controlled; and the production of coarse particles can be easily suppressed. The acrylic copolymer is more preferably a copolymer of monomers which contain 50.0% by mass to 99.9% by mass of methyl methacrylate and 0.1% by mass to 5.0% by mass of (meth)acrylic acid, still more preferably a copolymer of monomers which contain 50.0% by mass to 99.0% by mass of methyl methacrylate and 0.1% by mass to 5.0% by mass of (meth)acrylic acid, even more preferably a copolymer of monomers which contain 50.0% by mass to 98.0% by mass of methyl methacrylate, 1.0% by mass to 5.0% by mass of alkyl (meth)acrylate different from methyl methacrylate, and 0.1% by mass to 5.0% by mass of (meth)acrylic acid, and particularly preferably a copolymer of monomers which contain 50.0% by mass to 98.0% by mass of methyl methacrylate, 1.0% by mass to 5.0% by mass of alkyl (meth)acrylate different from methyl methacrylate, and 0.2% by mass to 3.0% by mass of (meth)acrylic acid.

As the alkyl (meth)acrylate different from methyl methacrylate, at least one selected from the group consisting of ethyl acrylate and butyl acrylate is preferred, from the point of view that the glass transition temperature can be controlled.

The acrylic copolymer may contain a small amount of monomer unit derived from another monomer that is different from any of (meth)acrylic acid ester and (meth)acrylic acid. In the total amount (100% by mass) of the monomers used for the synthesis of the acrylic copolymer, the content of the different monomer is preferably 30% by mass or less, more preferably 20% by mass or less, and still more preferably 10% by mass or less, from the point of view that the particle diameter of the colored resin particles can be easily controlled, and the production of coarse particles can be easily suppressed. It is most preferable that the different monomer is not contained.

As the different monomer, examples include, but are not limited to, the heteroatom-free monomers exemplified above and the heteroatom-containing monomers exemplified above other than the (meth)acrylic monovinyl monomers.

When used in the positively-chargeable toner, the acid value of the polar resin is preferably from 0.5 mgKOH/g to 7.0 mgKOH/g, more preferably from 1.0 mgKOH/g to 5.0 mgKOH/g, and still more preferably from 1.5 mgKOH/g to 3.0 mgKOH/g. When the acid value of the polar resin is within the above range, the effect of improving the heat-resistant storage stability, low temperature fixability and printing durability of the toner is high, and the effect of suppressing the production of coarse particles is also high.

The weight average molecular weight (Mw) of the polar resin is preferably from 8,000 to 45,000, more preferably from 9,000 to 45,000, and still more preferably from 10,000 to 40,000. When the weight average molecular weight (Mw) of the polar resin is equal to or more than the lower limit value, the heat-resistant storage stability and durability of the toner can be improved. When the weight average molecular weight (Mw) of the polar resin is equal to or less than the upper limit value, an increase in the fixing temperature of the toner can be suppressed.

The glass transition temperature (Tg) of the polar resin is preferably from 60° C. to 95° C., more is preferably from 65° C. to 90° C., and still more is preferably from 70° C. to 80° C.

When the glass transition temperature of the polar resin is equal to or more than the lower limit value, the heat-resistant storage stability of the toner can be improved. When the glass transition temperature of the toner is equal to or less than the upper limit value, the low temperature fixability of the toner can be improved.

The glass transition temperature (Tg) of the polar resin can be measured in the same manner as the glass transition temperature (Tg) of the charge control resin.

A commercially-available product can be used as the polar resin, or the polar resin can be produced by polymerizing a monomer containing the heteroatom-containing monomer by a known polymerization method such as a solution polymerization method, an aqueous solution method, polymerization an ionic polymerization method, a high-temperature and high-pressure polymerization method and a suspension polymerization method.

When the polar resin is a copolymer, the copolymer may be any of a random copolymer, a block copolymer and a graft copolymer. The copolymer is preferably a random copolymer.

From the viewpoint of improving solubility, the polar resin is preferably pulverized finely.

The content of the polar resin is preferably from 0.5 parts by mass to 2.5 parts by mass, more preferably from 0.8 parts by mass to 2.2 parts by mass, and still more preferably from 1.0 part by mass to 2.0 parts by mass, with respect to 100 parts by mass of the binder resin. When the content of the polar resin is equal to or more than the lower limit value, the particle diameter of the colored resin particles can be easily controlled, and the production of coarse particles can be easily suppressed. On the other hand, when the content of the polar resin is equal to or less than the upper limit value, an increase in the fixing temperature of the toner can be suppressed.

### [Softening Agent]

The softening agent comprises an ester wax having a molecular weight of from 600 to 3000. By containing the softening agent, the releasability of the toner from the fixing roller during the fixation of the toner can be improved. Among softening agents, the ester wax having a molecular weight of from 600 to 3000 is selected and contained as the softening agent; therefore, the generation of the UFP can be suppressed during the fixation of the toner, while improving the fixability of the toner. When the molecular weight of the ester wax is less than 600, UFP are likely to be generated during the fixation of the toner. When the molecular weight of the ester wax is more than 3000, the fixability of the toner deteriorates. The softening agent has the effect of decreasing the melt viscosity of the binder resin. However, when the molecular weight of the softening agent is too high, the effect of decreasing the melt viscosity of the binder resin diminishes, and the toner becomes less soluble. As a result, the fixability deteriorates. When the molecular weight of the softening agent is too high, the bleedability of the softening agent decreases. That is, the softening agent is less likely to migrate from the interior of the toner to the surface of the toner. Accordingly, the attachment effect by the softening agent is less likely to be exerted.

The molecular weight of the ester wax is preferably 800 or more, and more preferably 1000 or more as the lower limit. It is preferably 2800 or less, and more preferably 2700 or less as the upper limit.

The ester wax is a product produced by an ester reaction between alcohol and fatty acid.

The alcohol may be at least one kind of alcohol selected from the group consisting of monohydric alcohol and polyhydric alcohol.

As the monohydric alcohol, examples include, but are not limited to, a monohydric saturated aliphatic alcohol such as methanol, ethanol, 1-propanol, 2-propanol, 1-butanol, 2-butanol, 1-pentanol, 1-hexanol, octanol, 2-ethyl-1-hexanol, nonyl alcohol, lauryl alcohol, cetyl alcohol, stearyl alcohol and behenyl alcohol; a monohydric unsaturated aliphatic alcohol such as allyl alcohol, methallyl alcohol, crotyl alcohol and oleyl alcohol; a monohydric alicyclic alcohol such as cyclohexanol; and a monohydric aromatic alcohol such as phenol, phenylmethanol (benzyl alcohol), methylphenol (cresol), p-ethylphenol, dimethylphenol (xylenol), nonylphenol, dodecylphenol, phenylphenol and naphthol.

As the polyhydric alcohol, examples include, but are not limited to, a dihydric saturated aliphatic alcohol such as ethylene glycol and propylene glycol; a dihydric aromatic alcohol such as catechol and hydroquinone; and a trihydric or higher saturated aliphatic alcohol such as glycerol, pentaerythritol, dipentaerythritol, hexaglycerol and polyglycerol.

Of these monohydric and polyhydric alcohols, a polyhydric saturated aliphatic alcohol is preferred; a trihydric or higher saturated aliphatic alcohol is more preferred; a trihydric to octahydric saturated aliphatic alcohol is still more preferred; and hexaglycerol and pentaerythritol are particularly preferred, from the point of view that the ester wax having a molecular weight of from 600 to 3000 can be easily obtained, and that the low temperature fixability of the toner can be easily improved while suppressing the generation of the UFP.

The fatty acid serving as a raw material of the ester wax may be a monocarboxylic or polycarboxylic acid. The fatty acid is preferably a monocarboxylic acid. Also, the fatty acid may be at least one kind of fatty acid selected from the group consisting of a saturated fatty acid and an unsaturated fatty acid.

The number of the carbon atoms of the fatty acid, which is used as a raw material of the ester wax, is preferably 12 or more, more preferably 14 or more, and still more preferably 16 or more, as the lower limit. On the other hand, it is preferably 24 or less, more preferably 22 or less, and still more preferably 18 or less, as the upper limit. When the number of the carbon atoms of the fatty acid is equal to or more than the lower limit value, the generation of the UFP and the bleeding of the ester wax is likely to be suppressed. When the number of the carbon atoms of the fatty acid is equal to or less than the upper limit value, a decrease in the heat resistance of the toner is suppressed.

In addition, since the ester wax having a molecular weight of from 600 to 3000 is likely to be obtained, such a saturated fatty acid is particularly preferred, that the number of the carbon atoms it has is within the above range.

The saturated fatty acid is not particularly limited. As the saturated fatty acid, examples include, but are not limited to, lauric acid (12 carbon atoms), myristic acid (14 carbon atoms), pentadecylic acid (15 carbon atoms), palmitic acid (16 carbon atoms), margaric acid (17 carbon atoms), stearic acid (18 carbon atoms), arachidic acid (20 carbon atoms) and behenic acid (22 carbon atoms). Of them, palmitic acid (16 carbon atoms), behenic acid (22 carbon atoms) and stearic acid (18 carbon atoms) are preferred.

The unsaturated fatty acid is not particularly limited. As the unsaturated fatty acid, examples include, but are not limited to, the following fatty acids.
Palmitoleic acid (CH₃(CH₂)₅CH═CH(CH₂)₇COOH)
Oleic acid (CH₃(CH₂)₇CH═CH(CH₂)₇COOH).
Vaccenic acid (CH₃(CH₂)₅CH═CH(CH₂)₉COOH).
Linoleic acid (CH₃(CH₂)₃(CH₂CH═CH)₂(CH₂)₇COOH).
(9,12,15)-Linolenic acid (CH₃(CH₂CH═CH)₃(CH₂)₇COOH).
(6,9,12)-Linolenic acid (CH₃(CH₂)₃(CH₂CH═CH)₃(CH₂)₄COOH).
Eleostearic acid (CH₃(CH₂)₃(CH═CH)₃(CH₂)₇COOH).
Arachidonic acid (CH₃(CH₂)₃(CH₂CH═CH)₄(CH₂)₃COOH)

These fatty acids may be used alone or in combination of two or more.

The ester wax preferably has an esterification rate of 92% or more, more preferably 95% or more, and still more preferably 97% or more, from the viewpoint of improving the low temperature fixability of the toner by the sharp meltability of the ester wax.

The esterification rate of the ester wax is the proportion of the number of a hydroxyl group to which fatty acid is esterified, among the total number of hydroxyl groups contained in the raw material alcohol of the ester wax. The esterification rate of the ester wax can be obtained by measuring the saponification value (SV), hydroxyl value (OHV) and acid value (AV) of the ester wax and calculating the esterification rate by the following formula.

$$Esterification rate ( \% ) = [ ( SV - AV ) / ( SV - AV + OHV ) ] \times 100$$

The saponification value (SV) and acid value (AV) of the ester wax are measured according to JIS K 0070. The hydroxyl value (OHV) of the ester wax is measured according to JIS K 1557.

The ester wax may be a monoester or any one of polyfunctional esters such as a diester, a triester, a tetraester and a polyester. From the viewpoint of improving the low temperature fixability of the toner while suppressing the generation of the UFP, a polyfunctional ester is preferred, and a trifunctional to octafunctional ester is more preferred.

The ester wax having a molecular weight of from 600 to 3000 is not particularly limited. As the ester wax, for example, hexaglycerin octabehenate, pentaglycerol heptabehenate, tetraglycerol hexabehenate, triglycerol pentabehenate, diglycerol tetrabehenate, glycerol tribehenate, pentaerythritol tetrastearate, pentaerythritol tetrapalmitate, pentaerythritol tetramyristate, stearyl stearate, behenyl behenate, pentaerythritol tetrapalmitate, pentaerythritol tetrabehenate, dipentaerythritol hexalaurate, dipentaerythritol hexamyristate, dipentaerythritol hexapalmitate, dipentaerythritol hexastearate, dipentaerythritol hexabehenate, dipentaerythritol hexanonacosanate or the like is preferably used.

The ester waxes having a molecular weight of from 600 to 3000 may be used alone or in combination of two or more.

To the extent that does not impair the effects of the present disclosure, as the softening agent, a softening agent other than the ester wax having a molecular weight of from 600 to 3000 may be further contained.

As the softening agent other than the ester wax, examples include, but are not limited to, an ester wax having a molecular weight of less than 600, a hydrocarbon wax such as polyethylene wax, polypropylene wax, Fischer-Tropsch wax and petroleum wax; a natural wax such as jojoba; and a mineral wax such as ozokerite.

When each of the color toners contains, as the softening agent, the softening agent other than the ester wax having a molecular weight of from 600 to 3000, the content of the ester wax having a molecular weight of from 600 to 3000 in 100% by mass of the softening agent is preferably 90% by mass or more, more preferably 95% by mass or more, and still more preferably 99% by mass or more.

From the viewpoint of the viscoelasticity of the toner and from the viewpoint of improving the balance between the storage stability and low temperature fixability of the toner, the melting point of the softening agent is preferably in a range of 50° C. or more and 90° C. or less, more preferably in a range of 60° C. or more and 85° C. or less, and still more preferably in a range of 70° C. or more and 80° C. or less.

The content of the softening agent is not particularly limited. From the viewpoint of the viscoelasticity of the toner and from the viewpoint of improving the balance between the storage stability and low temperature fixability of the toner while suppressing the generation of the UFP, with respect to 100 parts by mass of the binder resin, the content of the softening agent is preferably 1 part by mass or more, and more preferably 5 parts by mass or more as the lower limit. It is preferably 30 parts by mass or less, more preferably 20 parts by mass or less, and still more preferably 10 parts by mass or less as the upper limit.

### [Molecular Weight Modifier]

It is preferable to use a molecular weight modifier as another additive, when the polymerizable monomer is polymerized into the binder resin.

The molecular weight modifier is not particularly limited, as long as it is one that is generally used as a molecular weight modifier for toners. As the molecular weight modifier, examples include, but are not limited to, a mercaptan such as t-dodecyl mercaptan, n-dodecyl mercaptan, n-octyl mercaptan and 2,2,4,6,6-pentamethylheptane-4-thiol, and a thiuram disulfide such as tetramethyl thiuram disulfide, tetraethyl thiuram disulfide, tetrabutyl thiuram disulfide, N,N′-dimethyl-N, N′-diphenyl thiuram disulfide and N,N′-dioctadecyl-N, N′-diisopropyl thiuram disulfide. These molecular weight modifiers may be used alone or in combination of two or more.

In the present disclosure, from the viewpoint of imparting the desired viscoelasticity to the toner, the molecular weight modifier is used in an amount of generally from 0.01 parts by mass to 10 parts by mass, preferably from 0.1 parts by mass to 5 parts by mass, and more preferably from 0.3 parts by mass to 3 parts by mass, with respect to 100 parts by mass of the binder resin or 100 parts by mass of the polymerizable (preferably monovinyl) monomer.

### (A-2) Suspension Step to Obtain Suspension (Droplets Forming Step)

In the present disclosure, it is preferable that the polymerizable monomer composition is dispersed in an aqueous medium preferably containing a dispersion stabilizer; a polymerization initiator is added therein; and then the polymerizable monomer composition is formed into droplets. The method for forming the droplets is not particularly limited. The droplets are formed, for example, by means of a device that enables strong stirring, such as an (in-line type) emulsifying and dispersing machine (product name: MILDER, manufactured by: Pacific Machinery & Engineering Co., Ltd.) and a high-speed emulsification dispersing machine (product name: T. K. HOMOMIXER MARK II, manufactured by: PRIMIX Corporation).

As the polymerization initiator, examples include, but are not limited to, a persulfate such as potassium persulfate and ammonium persulfate; an azo compound such as 4,4′-azobis (4-cyanovaleric acid), 2,2′-azobis(2-methyl-N-(2-hydroxyethyl) propionamide), 2,2′-azobis(2-amidinopropane) dihydrochloride, 2,2′-azobis(2,4-dimethylvaleronitrile) and 2,2′-azobisisobutyronitrile; and an organic peroxide such as di-t-butylperoxide, benzoylperoxide, t-butylperoxy-2-ethylhexanoate, t-butylperoxy diethylacetate, t-hexylperoxy-2-ethylbutanoate, diisopropylperoxydicarbonate, di-t-butylperoxyisophthalate and t-butylperoxyisobutyrate.

They may be used alone or in combination of two or more. Among them, the organic peroxide is preferably used since it can reduce a residual polymerizable monomer and since the toner with excellent printing durability can be obtained.

Among the organic peroxides, a peroxy ester is preferred, and a non-aromatic peroxy ester (i.e., a peroxy ester having no aromatic ring) is more preferred since they have good initiator efficiency and can reduce a residual polymerizable monomer.

The polymerization initiator may be added after dispersing the polymerizable monomer composition in the aqueous medium and before forming the droplets as described above, or it may be added to the polymerizable monomer composition before dispersing the polymerizable monomer composition in the aqueous medium.

In the present disclosure, the aqueous medium means a medium containing water as a main component. The dispersion stabilizer is preferably added to the aqueous medium. As the dispersion stabilizer, examples include, but are not limited to, the following inorganic and organic compounds: an inorganic compound such as a sulfate (e.g., barium sulfate and calcium sulfate), a carbonate (e.g., barium carbonate, calcium carbonate and magnesium carbonate), a phosphate (e.g., calcium phosphate), a metal oxide (e.g., aluminum oxide and titanium oxide) and a metal hydroxide (e.g., aluminum hydroxide, magnesium hydroxide and iron (II) hydroxide) and an organic compound such as a water-soluble polymer (e.g., polyvinyl alcohol, methyl cellulose and gelatin), an anionic surfactant, a nonionic surfactant and an ampholytic surfactant. These dispersion stabilizers may be used alone or in combination of two or more.

Among the above dispersion stabilizers, the inorganic compound is preferable, and a colloid of a sparingly water-soluble metal hydroxide is particularly preferable. The use of the inorganic compound, particularly the use of the colloid of the sparingly water-soluble metal hydroxide, can narrow the particle size distribution of the colored resin particles and can reduce the amount of the dispersion stabilizer remaining after washing. Accordingly, the toner thus obtained is capable of reproducing clear images and obtains excellent environmental stability.

### (A-3) Polymerization Step

In the aqueous medium, as described in the above (A-2), the polymerizable monomer composition is formed into droplets to obtain a suspension, and the obtained suspension is heated to polymerize the polymerizable monomer, thereby obtaining an aqueous dispersion of the colored resin particles.

The polymerization temperature of the polymerizable monomer composition is preferably 50° C. or more, and more preferably from 60° C. to 95° C. The polymerization reaction time is preferably from 1 hour to 20 hours, and more preferably from 2 hours to 15 hours.

The colored resin particles may be mixed with an external additive, and the mixture may be used as the toner. It is preferable to make the colored resin particles into so-called core-shell type (or “capsule type”) colored resin particles which are obtained by using the colored resin particles as the core layer and forming a shell layer, which is different from the core layer, outside the core layer. By covering the core layer, which is made of a substance having a low softening point, with a substance having a higher softening point, the core-shell type colored resin particles can take a balance of lowering the fixing temperature and prevention of aggregation during storage.

The method for producing the core-shell type colored resin particles by using the above-mentioned colored resin particles, is not particularly limited, and they can be produced by any conventional method. The in situ polymerization method and the phase separation method are preferable from the viewpoint of production efficiency.

Hereinafter, the method for producing the core-shell type colored resin particles according to the in situ polymerization method, will be described.

The core-shell type colored resin particles can be obtained by adding a polymerizable monomer for forming a shell layer (a polymerizable monomer for shell) and a polymerization initiator to the aqueous dispersion medium in which the colored resin particles are dispersed, and then polymerizing the monomer.

As the polymerizable monomer for shell, the above-mentioned polymerizable monomers can be similarly used. Among the polymerizable monomers, those that can provide a polymer having a Tg of more than 80° C., such as styrene, acrylonitrile and methyl methacrylate, preferably used alone or in combination of two or more.

As the polymerization initiator used for polymerization of the polymerizable monomer for shell, examples include, but are not limited to, a water-soluble polymerization initiator such as a metal persulfate (e.g., potassium persulfate and ammonium persulfate) and an azo-type initiator (e.g., 2,2′-azobis(2-methyl-N-(2-hydroxyethyl) propionamide) and 2,2′-azobis(2-methyl-N-(1,1-bis(hydroxymethyl)-2-hydroxyethyl) propionamide)). These polymerization initiators may be used alone or in combination of two or more. The amount of the polymerization initiator is preferably from 0.1 parts by mass to 30 parts by mass, and more preferably from 1 part by mass to 20 parts by mass, with respect to 100 parts by mass of the polymerizable monomer for shell.

The polymerization temperature of the shell layer is preferably 50° C. or more, and more preferably from 60° C. to 95° C. The polymerization reaction time is preferably from 1 hour to 20 hours, and more preferably from 2 hours to 15 hours.

### (A-4) Washing, Filtering, Dehydrating and Drying Steps

It is preferable that after the polymerization, the aqueous dispersion of the colored resin particles obtained by the polymerization is subjected to operations of washing for removal of the dispersion stabilizer, filtering, dehydrating, and drying repeatedly more than one time as needed, according to any conventional method.

The washing may be carried out as follows: when the inorganic compound is used as the dispersion stabilizer, it is preferable that the dispersion stabilizer is dissolved in water and removed by adding acid or alkali to the aqueous dispersion of the colored resin particles. When the colloid of the sparingly water-soluble inorganic hydroxide is used as the dispersion stabilizer, it is preferable that the pH of the aqueous dispersion of the colored resin particles is adjusted to 6.5 or less by adding acid. As the added acid, examples include inorganic acid such as sulfuric acid, hydrochloric acid and nitric acid, and organic acid such as formic acid and acetic acid. Among them, sulfuric acid is particularly preferable for its high removal efficiency and small impact on production facilities.

The dehydrating and filtering may be carried out by any of various known methods, without particular limitation. For example, a centrifugal filtration method, a vacuum filtration method and a pressure filtration method may be used. Also, the drying step may be carried out by any of various methods, without particular limitation.

### (B) Pulverization Method

In the case of producing the colored resin particles by employing the pulverization method, the production is carried out by the following steps, for example.

First, the binder resin, the colorant, the softening agent, the charge control agent and, as needed, another additive are mixed by means of a mixer such as a ball mill, a V type mixer, FM MIXER (product name, manufactured by Nippon Coke & Engineering Co., Ltd.), a high-speed dissolver and an internal mixer.

Next, the thus-obtained mixture is kneaded while heating by means of a press kneader, a twin screw kneading machine, a roller or the like. The thus-obtained kneaded product is coarsely pulverized by means of a pulverizer such as a hammer mill, a cutter mill and a roller mill. The coarsely pulverized product is pulverized by finely pulverizing by means of a pulverizer such as a jet mill and a high-speed rotary pulverizer. Then, the finely pulverized product is classified into the desired particle diameters by means of a classifier such as an air classifier and an airflow classifier, thereby obtaining colored resin particles produced by the pulverization method.

As the binder resin, the colorant, the softening agent, the charge control agent and another additive added as needed, those mentioned above in “(A) Suspension polymerization method” can be used in the pulverization method. Using the colored resin particles obtained by the pulverization method, core-shell type colored resin particles may be produced by the in situ polymerization method, etc., as with the colored resin particles obtained by the above-mentioned “(A) Suspension polymerization method”.

As the binder resin, other resins which are conventionally and broadly used in toners can be used. As the binder resin used in the pulverization method, examples include, but are not limited to, polystyrene, styrene-butyl acrylate copolymers, polyester resins and epoxy resins.

### 1-2. Colored Resin Particles

The colored resin particles are obtained by the above production method such as (A) Suspension polymerization method or (B) Pulverization method.

The colored resin particles constituting the toner will be described. The colored resin particles described below encompass both core-shell type colored resin particles and non-core-shell type colored resin particles.

The volume average particle diameter (Dv) of the colored resin particles is preferably from 3 μm to 15 μm, and more preferably from 4 μm to 12 μm. When the volume average particle diameter (Dv) is 3 μm or more, the flowability of the toner can be improved, and a deterioration in transferability and a decrease in image density can be suppressed. When the volume average particle diameter (Dv) is 15 μm or less, a decrease in image resolution can be suppressed.

As for the colored resin particles, the ratio (Dv/Dp) of the volume average particle diameter (Dv) to the number average particle diameter (Dp) is preferably from 1.0 to 1.3, and more preferably from 1.0 to 1.2. When the Dv/Dp ratio is 1.3 or less, a decrease in transferability, image density and resolution can be suppressed. The volume average particle diameter and number average particle diameter of the colored resin particles can be measured by means of a particle size analyzer using the Coulter counter method (e.g., product name: MULTISIZER; manufactured by: Beckman Coulter, Inc.), for example.

The average circularity of the colored resin particles is preferably from 0.97 to 1.00, and more preferably from 0.98 to 1.00, from the viewpoint of image reproducibility.

The term “circularity” is defined as a value obtained by dividing the perimeter of a circle having the same area as the projected area of a particle image, by the perimeter of the projected image of the particle.

Also in the present disclosure, the term “average circularity” is used as a simple method for quantitatively representing the shape of the particles and is the index of the degree of the surface roughness of the colored resin particles. The average circularity is 1 when the colored resin particles are perfectly spherical, and it gets smaller as the surface shape of the colored resin particles is more complex.

The average circularity (Ca) is a value obtained by the following average circularity calculation formula:

$$\begin{matrix}[ Math . 1 ] & \\ \begin{matrix}Average circularity calculation formula : \\ Average circularity ( Ca ) = ( {{\sum }_{i = 1}}^{n} ( Ci \times fi ) ) / {{\sum }_{i = 1}}^{n} ( fi )\end{matrix} & \end{matrix}$$

In the above formula, n is the number of particles for each of which the circularity Ci is obtained.

In the above formula, Ci is the circularity of each of particles having an equivalent circle diameter of from 0.6 μm to 400 μm and is calculated by the following circularity calculation formula based on the perimeter measured for each particle:

$$Circularity calculation formula circularity ( Ci ) = ( Perimeter of a circle having the same area as the projected area of a particle image ) / ( Perimeter of the projected particle image )$$

In the above formula, “fi” is the frequency of the particles having the circularity Ci.

The circularity and the average circularity can be measured by means of flow particle image analyzer “FPIA-3000” (product name, manufactured by: Sysmex Corporation).

The presence or absence of the external additive does not cause a significant difference in the values of the volume average particle diameter (Dv), number average particle diameter (Dp) and average circularity of the toner. Accordingly, the values of the volume average particle diameter (Dv), number average particle diameter (Dp) and average circularity of the toner which contains the external additive, can be deemed identical to those of the colored resin particles which does not contain the external additive.

### 1-3. External Additive

By mixing and stirring the above-mentioned colored resin particles with an external additive, the external additive may be uniformly added (external addition) on the surface of the colored resin particles. The external additive is added on the surface of the colored resin particles, thereby obtaining a one-component toner (a developer). The one-component toner may be further mixed and stirred with carrier particles to make a two-component toner.

A mixer used for the external addition treatment is not particularly limited, as long as it is a mixer capable of adding the external additive on the surface of the colored resin particles. For example, the external addition can be carried out by means of a mixer capable of mixing and stirring, such as HENSCHEL MIXER (: product name, manufactured by Mitsui Mining Co., Ltd.), FM MIXER (: product name, manufactured by Nippon Coke & Engineering Co., Ltd.), SUPER MIXER (: product name, manufactured by KAWATA Manufacturing Co., Ltd.), Q MIXER (: product name, manufactured by NIPPON COKE & ENGINEERING CO., LTD.), MECHANOFUSION SYSTEM (: product name, manufactured by Hosokawa Micron Corporation) and MECHANOMILL (: product name, manufactured by Okada Seiko Co., Ltd.)

As the external additive, particles which are made of an appropriate material and which have an appropriate particle diameter may be selected from various kinds of inorganic and organic fine particles and used.

As the external additive, examples include, but are not limited to, inorganic fine particles such as fine particles of silica, titanium oxide, aluminum oxide, zinc oxide, tin oxide, calcium carbonate, calcium phosphate and cerium oxide, and organic fine particles such as fine particles of polymethyl methacrylate resin, silicone resin and melamine resin. Among them, at least the inorganic fine particles are preferred. Among the inorganic fine particles, at least one kind of fine particles selected from the group consisting of silica fine particles and titanium oxide fine particles are preferred, and silica fine particles are particularly preferred.

The external additives may be used alone or in combination of two or more.

The number average primary particle diameter of the external additive can be measured by a conventionally known method. For example, it can be measured as follows.

First, the particle diameters of the particles of the external additive are measured by means of a transmission electron Microscope (TEM), a scanning electron microscope (SEM) or the like. For each external additive, the particle diameters of at least 30 particles are measured in this manner, and the average is determined as the number average particle diameter of the particles. When it is found by TEM or SEM observation, that the form of the particles is a non-spherical form and the particles have long and short diameters, first, the long and short diameters are measured for each external additive. As just described, for each external additive particle, the long diameter and short diameter of at least 30 particles are measured, and the averages are determined as the average long diameter and average short diameter of the external additive, respectively. The total value of the calculated average long diameter and average short diameter is divided by 2, and the value thus obtained is determined as the number average primary particle diameter of the external additive.

Each of the color toners included in the toner set of the present disclosure preferably contains, as the external additive, inorganic fine particles A having a number average primary particle diameter of from 36 nm to 100 nm.

When the number average primary particle diameter of the inorganic fine particles A is less than 36 nm, an adverse effect on printing performance (e.g., fog) may occur due to a decrease in the spacer effect thereof. On the other hand, when the number average primary particle diameter of the inorganic fine particles A is more than 100 nm, the flowability of the toner may decrease; moreover, since the inorganic fine particles A are likely to be released from the surface of the toner particles, the function of the inorganic fine particles A as the external additive decreases, and an adverse effect on printing performance may occur, accordingly.

The number average primary particle diameter of the inorganic fine particles A is more preferably 40 nm or more, and still more preferably from 45 nm or more as the lower limit. On the other hand, it is more preferably 80 nm or less, and still more preferably 70 nm or less as the upper limit. Also, the inorganic fine particles A are preferably hydrophobized particles.

In the present disclosure, for example, a silane coupling agent, silicone oil, fatty acid, fatty acid metal salt or the like can be used as the hydrophobizing agent. Among them, a silane coupling agent and silicone oil are preferred.

The content of the inorganic fine particles A with respect to 100 parts by mass of the binder resin in the colored resin particles, is preferably 0.30 parts by mass or more, more preferably 0.50 parts by mass or more, and still more preferably 1.00 part by mass or more as the lower limit. On the other hand, it is preferably 2.50 parts by mass or less, more preferably 2.00 parts by mass or less, and still more preferably 1.50 parts by mass or less as the upper limit.

When the content of the inorganic fine particles A is equal to or more than the lower limit value, the inorganic fine particles A can sufficiently function as the external additive. Accordingly, a deterioration in printing performance or storage stability is suppressed. On the other hand, when the content of the inorganic fine particles A is equal to or less than the upper limit value, the release of the inorganic fine particles A from the surface of the toner particles is suppressed. Accordingly, a deterioration in printing performance is suppressed.

In the present disclosure, as the external additive, the toner preferably contains inorganic fine particles B having a number average primary particle diameter of from 15 nm to 35 nm.

When the number average primary particle diameter of the inorganic fine particles B is less than 15 nm, the inorganic fine particles B easily penetrate from the surface of the colored resin particles to the inside of the colored resin particles. Accordingly, sufficient flowability cannot be imparted to the toner particles, and an adverse effect may be imposed on printing performance. On the other hand, when the number average primary particle diameter of the inorganic fine particles B is more than 35 nm, the proportion of the inorganic fine particles B to the surface of the toner particles (the surface coverage) decreases. Accordingly, sufficient flowability may not be imparted to the toner particles.

The number average primary particle diameter of the inorganic fine particles B is more preferably 17 nm or more, and still more preferably 20 nm or more as the lower limit. On the other hand, it is more preferably 30 nm or less, and still more preferably 25 nm or less as the upper limit. Also, the inorganic fine particles B are preferably hydrophobized particles.

The content of the inorganic fine particles B with respect to 100 parts by mass of the binder resin in the colored resin particles, is preferably 0.10 parts by mass or more, more preferably 0.30 parts by mass or more, and still more preferably 0.50 parts by mass or more as the lower limit, with respect to 100 parts by mass of the binder resin in the colored resin particles. On the other hand, it is preferably 2.00 parts by mass or less, more preferably 1.50 parts by mass or less, and still more preferably 1.00 part by mass or less as the upper limit.

When the content of the inorganic fine particles B is equal to or more than the lower limit value, the inorganic fine particles B can sufficiently function as the external additive. Accordingly, a decrease in flowability is suppressed, and a deterioration in storage stability or durability is suppressed. On the other hand, when the content of the inorganic fine particles B is equal to or less than the upper limit value, the release of the inorganic fine particles B from the surface of the toner particles is suppressed. Accordingly, a deterioration in charge property is suppressed, thereby suppressing the occurrence of fog.

In the present disclosure, as the external additive, the toner preferably contains inorganic fine particles C having a number average primary particle diameter of from 6 nm to 14 nm.

When the number average primary particle diameter of the inorganic fine particles C is less than 6 nm, the inorganic fine particles C easily penetrate from the surface of the colored resin particles to the inside of the colored resin particles. Accordingly, sufficient flowability cannot be imparted to the toner particles, and an adverse effect may be imposed on printing performance, therefore. On the other hand, when the number average primary particle diameter of the inorganic fine particles C is more than 14 nm, the proportion of the inorganic fine particles C to the surface of the toner particles (the surface coverage) decreases. Accordingly, sufficient flowability may not be imparted to the toner particles.

The number average primary particle diameter of the inorganic fine particles C is more preferably 6.5 nm or more, and still more preferably 7.0 nm or more as the lower limit. On the other hand, it is more preferably 12 nm or less, and still more preferably 10 nm or less as the upper limit. Also, the inorganic fine particles C are preferably hydrophobized particles.

The content of the inorganic fine particles C with respect to 100 parts by mass of the binder resin in the colored resin particles, is preferably 0.10 parts by mass or more, more preferably 0.15 parts by mass or more, and still more preferably 0.20 parts by mass or more as the lower limit. On the other hand, it is preferably 1.50 parts by mass or less, more preferably 1.00 part by mass or less, still more preferably 0.80 parts by mass or less, and even more preferably 0.60 parts by mass or less as the upper limit.

When the content of the inorganic fine particles C is equal to or more than the lower limit value, the inorganic fine particles C can sufficiently function as the external additive. Accordingly, a decrease in flowability is suppressed, and a deterioration in storage stability is suppressed. On the other hand, when the content of the inorganic fine particles C is equal to or less than the upper limit value, the release of the inorganic fine particles from the surface of the toner particles is suppressed. Accordingly, a deterioration in charging properties is suppressed, thereby suppressing the occurrence of fog.

Each of the color toners included in the toner set of the present disclosure preferably contains, as the external additive, any one of the inorganic fine particles A to C, more preferably contains any two of them, and still more preferably contains all of them.

As the inorganic fine particles A, B and C, examples include, but are not limited to, inorganic fine particles of silica, titanium oxide, aluminum oxide, zinc oxide, tin oxide, calcium carbonate, calcium phosphate and cerium oxide. The inorganic fine particles A to C may be made of different materials. However, it is preferable that they are made of the same material. It is preferable that all of the inorganic fine particles A to C are at least one kind of particles selected from the group consisting of silica fine particles and titanium oxide fine particles, and it is more preferable that all of the inorganic fine particles A to Care silica fine particles.

Various kinds of commercially-available silica fine particles can be used as the inorganic fine particles A, such as VPNA50H (product name, manufactured by: Nippon Aerosil Co., Ltd., number average primary particle diameter: 40 nm) and H05TA (product name, manufactured by: Clariant Corporation, number average primary particle diameter: 50 nm).

Various kinds of commercially-available silica fine particles can be used as the inorganic fine particles B, such as NA50Y (product name, manufactured by: Nippon Aerosil Co., Ltd., number average primary particle diameter: 35 nm), MSP-012 (product name, manufactured by: Tayca Corporation, number average primary particle diameter: 16 nm) and TG-7120 (product name, manufactured by: Cabot Corporation, number average primary particle diameter: 20 nm).

Various kinds of commercially-available silica fine particles can be used as the inorganic fine particles C, such as HDK2150 (product name, manufactured by: Clariant Corporation, number average primary particle diameter: 12 nm), R504 (product name, manufactured by: Nippon Aerosil Co., Ltd., number average primary particle diameter: 12 nm), RA200HS (product name, manufactured by: Nippon Aerosil Co., Ltd., number average primary particle diameter: 12 nm), MSP-013 (product name, manufactured by: Tayca Corporation, number average primary particle diameter: 12 nm) and TG-820F (product name, manufactured by: Cabot Corporation, number average primary particle diameter: 7 nm).

The yellow and cyan toners included in the toner set of the present disclosure preferably further contain, as the external additive, organic fine particles D having a number average primary particle diameter of 1.0 μm or less. Accordingly, the toners having the desired flowability can be easily obtained. When the toners contain the organic fine particles D as the external additive, filming on a photoconductor is less likely to occur, and the toner particles are provided with stable charging properties over time, so that such toners are obtained, that a deterioration in image quality (e.g., fog) is less likely to occur even after continuous printing is carried out on many sheets, and a deterioration in image quality is less likely to occur especially even under a high temperature and high humidity environment (HH environment).

From the point of view that these effects can be easily exerted by the organic fine particles D, the number average primary particle diameter of the organic fine particles D is preferably 0.3 μm or more, more preferably 0.4 μm or more, and still more preferably 0.5 μm or more as the lower limit. On the other hand, it is more preferably 0.9 μm or less, and still more preferably 0.8 μm or less as the upper limit.

The content of the organic fine particles D with respect to 100 parts by mass of the binder resin in the colored resin particles, is preferably 0.01 parts by mass or more, more preferably 0.02 parts by mass or more, still more preferably 0.03 parts by mass or more, and even more preferably 0.04 parts by mass or more as the lower limit. On the other hand, it is preferably 0.19 parts by mass or less, more preferably 0.17 parts by mass or less, and still more preferably 0.15 parts by mass or less as the upper limit.

When the content of the organic fine particles D is equal to or more than the lower limit value, the aggregation of the toner can be easily suppressed, and the occurrence of spouting of the toner is suppressed, accordingly. In addition, when the content of the organic fine particles D is equal to or more than the lower limit value, the organic fine particles D can sufficiently function as the external additive. Accordingly, a reduction in charging properties in a high temperature and high humidity environment is suppressed, and the occurrence of fog can be suppressed. On the other hand, when the content of the organic fine particles D is equal to or less than the upper limit value, a deterioration in the fixability of the toner, which is due to the large external additive amount, can be suppressed. In addition, when the content of the organic fine particles D is equal to or less than the upper limit value, the release of the organic fine particles D from the surface of the toner particles is suppressed, and a decrease in flowability is suppressed, accordingly.

As the organic fine particles D, fatty acid metal salt particles are preferably used. The fatty acid (R—COOH) that serves to derive the fatty acid moiety (R—COO⁻) of the fatty acid metal salt particles may be a monocarboxylic acid containing only one carboxyl group (—COOH), and it is preferably a monocarboxylic acid having a chain structure, more preferably a saturated monocarboxylic acid having a chain structure, and still more preferably a linear saturated monocarboxylic acid.

Also, the fatty acid moiety (R—COO⁻) of the fatty acid metal salt particles is preferably one derived from a higher fatty acid in which the alkyl group (R—) has many carbon atoms. The number of the carbon atoms of the alkyl group in the fatty acid moiety is not particularly limited. It is preferably from 12 to 24, more preferably from 14 to 22, and still more preferably from 16 to 20.

As the higher fatty acid that is preferably used as a raw material for the fatty acid metal salt particles, examples include, but are not limited to, lauric acid (CH₃(CH₂)₁₀COOH), tridecanoic acid (CH₃(CH₂)COOH), myristic acid (CH₃(CH₂)₁₂COOH), pentadecanoic acid (CH₃(CH₂)₁₃COOH), palmitic acid (CH₃(CH₂)₁₄COOH), heptadecanoic acid (CH₃(CH₂)₁₅COOH), stearic acid (CH₃(CH₂)₁₆COOH), arachidic acid (CH₃(CH₂)₁₈COOH), behenic acid (CH₃(CH₂)₂₀COOH) and lignoceric acid (CH₃(CH₂)₂₂COOH). Of them, stearic acid and behenic acid are preferred, and stearic acid is more preferred.

These fatty acids that are preferably used as a raw material for the fatty acid metal salt particles, may be used alone or in combination of two or more. From the viewpoint of obtaining a uniform toner property, any one kind of the fatty acids is preferably used alone.

The metal contained in the fatty acid metal salt particles may be an alkaline metal, an alkaline-earth metal or a metal element of the Group 12 of the periodic table, such as Li, Na, K, Rb, Cs, Be, Mg, Ca, Sr, Ba and Zn. Of them, an alkaline-earth metal or a metal element of the Group 12 of the periodic table is preferred; at least one selected from the group consisting of Mg and Zn is more preferred; and Zn is still more preferred.

As the fatty acid metal salt particles, various kinds of commercially-available products can be used. As the products, examples include, but are not limited to, SPZ-100F (product name, zinc stearate particles manufactured by: Sakai Chemical Industry Co., Ltd., number average primary particle diameter: 0.5 μm) and SPX-100F (product magnesium name, stearate particles manufactured by: Sakai Chemical Industry Co., Ltd., number average primary particle diameter: 0.72 μm).

As the external addition treatment method, the following method may be employed: an external addition treatment including the following steps: the first step intermediate particles are obtained by mixing and stirring part of the external additive to be added and the colored resin particles and then drying them, and the second step in which the rest of the external additive and the intermediate particles are mixed and stirred. As just described, by carrying out the external addition treatment in two steps, the external additive added before drying the colored resin particles is relatively likely to penetrate to the surface of the colored resin particles, and the external additive added after drying the colored resin particles is relatively unlikely to penetrate to the surface of the colored resin particles. Accordingly, the toner having the desired flowability can be easily obtained.

In the first step of the external addition treatment, it is preferable that the colored resin particles in a wet state are dried while mixing them with the external additive and stirring them. That is, it is preferable to carry out the mixing and stirring concurrently with the drying. The drying method employed in the first step of the external addition treatment is not particularly limited. For example, reduced-pressure drying, vacuum drying, heat drying or the like can be employed.

The second step of the external addition treatment is not particularly limited. For example, the above-described mixer capable of mixing and stirring can be used.

The method for carrying out the external addition treatment in two steps is particularly preferred especially in the case of adding the organic fine particles D as the external additive.

The external additive added in the first step of the external addition treatment preferably contains the inorganic fine particles C. More preferably, it is composed of the inorganic fine particles C.

The external additive added in the second step of the external addition treatment preferably contains the organic fine particles D. More preferably, it contains the organic fine particles D and the inorganic fine particles A and B.

The content of the external additive is not particularly limited, and it is appropriately adjusted so that the toner obtains the desired viscoelasticity. The content of the external additive is preferably 0.05 parts by mass or more and 6 parts by mass or less, more preferably 0.2 parts by mass or more and 5 parts by mass or less, and still more preferably 0.5 parts by mass or more and 3 parts by mass or less, with respect to 100 parts by mass of the colored resin particles. When the content of the external additive is equal to or more than the lower limit value, the production of a transfer residue can be suppressed. When the content is equal to or less than the upper limit value, fogging can be suppressed.

### 1-4. Toner Viscoelasticity

In the toner set of the present disclosure, the color toners comprise at least a yellow toner, a magenta toner and a cyan toner, and the loss tangent of the yellow toner at 100° C. (tanδ (Y, 100° C.)), the loss tangent of the magenta toner at 100° C. (tanδ (M, 100° C.)) and the loss tangent of the cyan toner at 100° C. (tanδ (C, 100° C.)) are all 0.840 or more and have such viscoelasticity that satisfies the following formulae (I), (II) and (III):

$$\vert tan δ ( M , 100 ° C . ) - tan δ ( Y , 100 ° C . ) \vert \leq 0.14 \qquad ( I )$$

$$\vert tan δ ( M , 100 ° C . ) - tan δ ( C , 100 ° C . ) \vert \leq 0.14 \qquad ( II )$$

$$\vert tan δ ( Y , 100 ° C . ) - tan δ ( C , 100 ° C . ) \vert \leq 0.14 . \qquad ( III )$$

In the present disclosure, the loss tangent (tanδ) is defined as the ratio (G″/G′) between the storage elastic modulus (G′) and loss elastic modulus (G″) measured by the dynamic viscoelastic measurement.

In the present disclosure, the value of the tanδ is rounded to the third decimal place according to the rule B of JIS Z8401:1999.

The loss tangent of the toner at each temperature is specified from the temperature dependence curve of the loss tangent (tanδ) of the toner obtained by dynamic viscoelasticity measurement. In the present disclosure, the temperature dependence curve for the loss tangent (tanδ) obtained by the dynamic viscoelasticity measurement may be referred to as “temperature-tanδ curve”.

In the present disclosure, the dynamic viscoelastic measurement is carried out using a rotating flat plate rheometer (product name: ARES-G2, manufactured by: TA Instruments Inc.) and using a parallel plate or a cross-hatch plate under the following conditions.
Frequency: 24 Hz
Sample set: A test piece (2 mm to 4 mm thick) is sandwiched between 8 mm φ plates with a 20 g load; the test piece is fused to a jig by increasing the temperature to 80° C.; the temperature is returned to 45° C.; then, increasing the temperature (temperature increase) is started.
Temperature increase rate: 5° C./min
Temperature range: 40° C. to 190° C.

For example, the test piece can be produced by pouring 0.2 g of the toner of the present disclosure into a cylindrical mold of 8 mm φ and pressurizing the toner at 1.0 MPa for 30 seconds, thereby forming a columnar molded body having a diameter of 8 mm φ and a thickness of 2 mm to 4 mm.

In the toner set of the present disclosure, the yellow, magenta and cyan toners have the above-described viscoelasticity, and the toners contain the ester wax having a molecular weight of from 600 to 3000 as the softening agent. Accordingly, peeling of the toner layer(s) of a full-color image thus formed, is suppressed, thereby improving the fixation of the toner layers. Peeling of the toner layer(s) of the full-color image thus formed, means peeling of the toner layers from the surface of a paper, which occurs in the interface therebetween, peeling between the toner layers, and peeling occurring within the toner layer(s), for example. For the purpose of suppressing the peeling of the toner layer(s) to improve the fixation of the toner layers, the following (i) and (ii) needs to be achieved: (i) the heat of the fixing roller reaches the toner layers and the paper layer, and the toner is melted to the extent that it attaches onto the paper surface, and (ii) the softening agent contained in the toner seeps out of the toner and contributes to the attachment of the layers. The (ii) is achieved when the color toners contain the ester wax having a molecular weight of from 600 to 3000 as the softening agent.

The (i) is achieved when the color toners have the above-described viscoelasticity. More specifically, since the loss tangents of the yellow, magenta and cyan toners at 100° C. (tanδ's (100° C.)) are high and equal to or higher than a certain value, the toners can easily melt and spread. In addition, since the difference between the loss tangents of the color toners at 100° C. is small and equal to or smaller than a certain value, melting of the toner having a relatively low tanδ (100° C.) also occurs, resulting in an improvement in the attachment of the toner layers and the attachment of the toner layers to the paper surface. Accordingly, the (i) is achieved. When the difference between the tanδ's (100° C.) of the color toners is large, incomplete melting of the toner having a relatively low tanδ (100° C.) occurs, resulting in poor attachment of the toner layers or poor attachment of the toner layers to the paper surface.

In the toner set of the present disclosure, the absolute value of the difference between tanδ (Y, 100° C.) and tanδ (M, 100° C.), the absolute value of the difference between tanδ (C, 100° C.) and tanδ (M, 100° C.), and the absolute value of the difference between tanδ (Y, 100° C.) and tanδ (C, 100° C.) are only required to be 0.140 or less. The absolute values are preferably, but are not limited to, 0.120 or less, and more preferably 0.100 or less as the upper limit. From the viewpoint of suppressing the peeling between the toner layers and the peeling occurring within the toner layer(s), the difference between the loss tangents of the toners at 100° C. (tanδ's (100° C.)) is preferably as small as possible. However, from the viewpoint of ease of production, the difference may be 0.0001 or more, or it may be 0.001 or more, for example.

In the toner set of the present disclosure, all of the tanδ (Y, 100° C.), the tanδ (M, 100° C.) and the tanδ (C, 100° C.) are only required to be 0.840 or more. From the viewpoint of suppressing the peeling of the toner layer(s) and from the viewpoint of improving the fixability of the toner, they are preferably 0.850 or more, and more preferably 0.860 or more. The upper limit of the tanδ (Y, 100° C.), that of the tanδ (M, 100° C.) and that of the tanδ (C, 100° C.) particularly limited. From the viewpoint of hot offset resistance and from the viewpoint of suppressing a decrease in storage stability and suppressing a decrease in image glossiness, they are preferably 0.960 or less, more preferably 0.950 or less, and still more preferably 0.940 or less.

The viscoelasticity of the color toners can be controlled by, for example, the type, amount of the like of the added molecular weight modifier, colorant, charge control resin, polar resin and so on.

### 2. Image Forming Method

The toner set of the present disclosure is typically a color toner set for developing electrostatic images, which is used to form full-color images by electrostatic image development.

The method for forming a full-color image by electrostatic image development, is broadly classified into the following two methods, based on differences in transfer steps.
(1) A method in which an original image is subjected to color separation to obtain the data of color components; based on the data of the color components, single toner images of multiple colors are formed; the toner images are sequentially transferred onto one transfer medium to overlap the colors on the transfer medium, thereby forming a full-color image; and then the full-color image is transferred from the transfer medium to a recording medium.
(2) A method in which an original image is subjected to color separation to obtain the data of color components; based on the data of the color components, single toner images of multiple colors are formed; and the toner images are sequentially transferred onto one recording medium to overlap the colors on the recording medium, thereby forming a full-color image.

The toner set of the present disclosure can suppress the peeling of the toner layer(s) and the generation of the ultrafine particles in both of the above methods.

The present disclosure also encompasses the following two image forming methods. One is the method in which the colors are overlapped on the transfer medium, and the other is the method in which the colors are overlapped on the recording medium.

The first method is a method for forming an image by an electrostatic image development type full-color printer using the toner set of the present disclosure,
the method comprising:
developing a first image which is a primary color image formed with the first toner (the first image developing step),
developing second images which are primary color images formed with the second toners (the second images developing step),
forming an image including a higher-order color on a transfer medium by transferring the first image and then the second images onto the transfer medium (the step of overlapping colors on a transfer medium),
transferring the image including the higher-order color formed on the transfer medium onto a recording medium (the higher-order color image transferring step), and
fixing the image including the higher-order color transferred onto the recording medium on the recording medium (the fixing step).

The second method is a method for forming an image by an electrostatic image development type full-color printer using the toner set of the present disclosure,
the method comprising:
developing a first image which is a primary color image formed with the first toner (the first image developing step),
developing second images which are primary color images formed with the second toners (the second images developing step),
forming an image including a higher-order color on a recording medium by transferring the first image and then the second images onto the recording medium (the step of overlapping colors on a recording medium), and
fixing the image including the higher-order color transferred onto the recording medium on the recording medium (the fixing step).

In the present disclosure, the term “primary color” means a color obtained by printing with a single color toner; the term “secondary color” means a color obtained by overlapping primary color toner images of two colors; and the term “higher-order color” means a color obtained by overlapping primary color toner images of multiple colors.

Also in the present disclosure, the term “toner image” literally means an image formed with a toner. In particular, the term is used to emphasize the following: the state that the toner is distributed according to an image required to be reproduced on an image holding surface such as a photoconductor, transfer medium or recording medium, is detected as a visual image.

Also in the present disclosure, the term “initial color” means the color of a primary color toner image which is transferred first onto a transfer receptive medium when a full-color image is formed as follows: primary color toner images of various colors are formed by use of toner developing devices; the toner images are sequentially transferred onto one transfer receptive medium (a recording medium or a transfer medium) to overlap the colors on the transfer receptive medium, thereby forming a full-color image.

Also in the present disclosure, the term “initial developing device” means a developing device used to develop a primary color toner image of the initial color. When toner developing devices are aligned in series along the conveyor path of the transfer receptive medium (recording medium or transfer medium) in a developing system, the developing device that the transfer receptive medium following the conveyor path meets first, is the “initial developing device”.

The toner set of the present disclosure is preferably applied to the following printing method: by use of primary color toners such as yellow, cyan and magenta toners, electrostatic latent images corresponding to the primary colors are developed to form primary color toner images on developing devices, and the obtained primary color toner images are sequentially transferred onto one transfer receptive medium selected from the group consisting of a recording medium and a transfer medium to overlap the colors on the transfer receptive medium, thereby forming a full-color image.

In the case of overlapping the colors on the recording medium, the primary color toner images are sequentially transferred from the surfaces having the toner images formed thereon of the developing devices onto the recording medium directly or via an intermediate transfer step of being transferred onto the transfer medium, thereby forming a full-color image including a higher-order color on the recording medium.

In the case of overlapping the colors on the transfer medium, the primary color toner images are sequentially transferred from the surfaces having the toner images formed thereon of the developing devices onto one transfer medium directly or via an intermediate transfer step of being transferred onto another preceding transfer medium, thereby forming a full-color image including a higher-order color on the transfer medium. Then, the full-color image formed on the transfer medium is transferred onto the recording medium directly or via an intermediate transfer step onto another subsequent transfer medium.

The first toner included in the toner set of the present disclosure is the primary color toner which is transferred first onto the transfer receptive medium in the process of overlapping the colors on one transfer receptive medium selected from the group consisting of a recording medium and a transfer medium. The second toners included in the toner set are the primary color toners which are transferred second or later in the process of overlapping the colors on the transfer receptive medium.

The first toner is generally selected from the group consisting of a yellow toner, a cyan toner and a magenta toner.

The second toners are generally selected from the group consisting of the yellow toner, the cyan toner and the magenta toner so that the relationship with adjacent overlapped toners satisfies the formula (I), (II) or (III). In the image forming method using the toner set of the present disclosure, a different color toner such as a black toner may be further used. In addition to the yellow, cyan and magenta toners which are the reference yellow, cyan and magenta colors, another yellow, cyan or magenta toner or the like, which is different in color parameters (e.g., hue, color density, lightness and chroma) from the toner of the reference yellow, cyan or magenta color, may be used.

As the transfer medium used to overlap the colors thereon, examples include, but t are not limited to, an intermediate transfer belt and an intermediate transfer roller.

As the recording medium, examples include, but are not limited to, a coated paper, an art paper, an OHP sheet, as well as a recording paper such as a plain paper.

As the printing device that can execute the above-mentioned process, the following full-color printer may be used, for example: a full-color printer in which developing devices corresponding to the color toners included in the toner set are aligned in series, and primary color images produced by the developing devices (color separation images) are sequentially transferred from the developing devices onto one recording medium directly or via a transfer medium to form an image including a secondary or higher-order color on the recording medium. This is a type of so-called tandem printer.

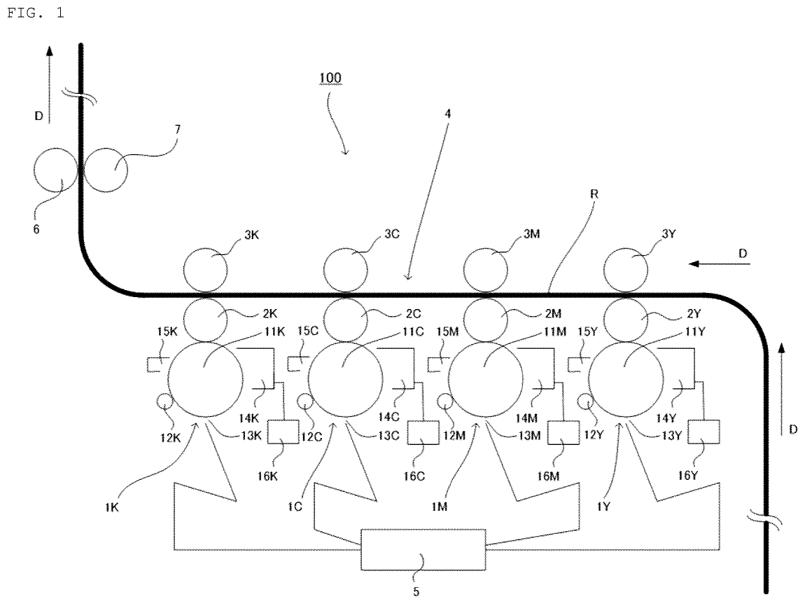

FIG. 1 is a schematic view of an example of the image forming device to which the toner set of the present disclosure is applicable. The image forming method of the present disclosure is not limited to the one shown in FIG. 1. The structure, size and form of the materials used in the method of the present disclosure are not limited to those of the materials shown in FIG. 1.

An image forming device 100 shown in FIG. 1 is a tandem printer. The image forming device 100 includes the following components: a conveyor path 4 for conveying a recording medium R; four developing devices 1Y, 1M, 1C and 1K corresponding to the four colors of yellow (Y), magenta (M), cyan (C) and black (K), respectively; transfer mediums 2Y, 2M, 2C and 2K and support rollers 3Y, 3M, 3C and 3K corresponding to the four developing devices 1Y, 1M, 1C and 1K, respectively; an exposure device 5 for applying laser light according to primary color image data obtained by color separation of the original image; and a fixing roller 6 and a support roller 7, which are paired with each other. The four developing devices 1Y, 1M, 1C and 1K corresponding to the four colors of yellow (Y), magenta (M), cyan (C) and black (K), respectively, are aligned in series along the conveying direction D of the recording medium R in the image forming device. The four developing devices are aligned in the following order from the upstream side of the conveying direction: the yellow developing device 1Y, the magenta developing device 1M, the cyan developing device 1C, and the black developing device 1K.

The structure of the developing devices will be described with reference to the yellow developing device 1Y as a representative example. The developing device 1Y includes a photoconductor 11Y in a drum form, and the following components are disposed around the photoconductor 11Y: a charging roller 12Y for charging the photoconductor surface to a predetermined voltage; a laser light irradiator 13Y for irradiating the photoconductor 11Y with the laser light produced in the exposure device to form an electrostatic image; a developing section 14Y for developing the electrostatic image by supplying a charged toner to the electrostatic image; the transfer medium 2Y in a roller form for transferring the developed toner image; and a cleaner 15Y for removal of the toner remaining on the photoconductor 11Y after the toner image is transferred onto the transfer medium. The developing section 14Y is connected to a toner storage 16Y through a yellow toner supply path.

As with the yellow developing device 1Y, the remaining developing devices of other colors include a photoconductor (11M, 11C, 11K), a charging roller (12M, 12C, 12K), a laser light irradiator (13M, 13C, 13K), a developing section (14M, 14C, 14K), a cleaner (15M, 15C, 15K) and a toner storage (16M, 16C, 16K). These components and a transfer medium (2M, 2C, 2K) are disposed around the photoconductor.

The method for forming an image by use of the image forming device 100 will be described. In this device, the yellow toner is selected as the first toner and used in the initial developing device 1Y. The magenta (M), cyan (C) and black (K) toners are used in the second and subsequent developing devices as the second toners.

First, in the yellow developing device 1Y, the surface of the photoconductor 11Y is uniformly charged by the charging roller 12Y. A photoconductor generally has high resistance (the resistance of general resin); however, it is characterized in that once irradiated with laser light, the specific resistance of a laser-irradiated part is changed. Accordingly, laser light is produced by the exposure device 5 according to the primary color image data of yellow, and the surface of the charged photoconductor 1Y is irradiated with the laser light by the laser light irradiator 13Y. A photosensitive layer on the surface of the photoconductor 11Y is irradiated with the laser light, thereby forming an electrostatic latent image corresponding to the primary color image of yellow on the surface of the photoconductor 11Y.

The electrostatic latent image is formed by the charge left in a part not irradiated with the laser light. Accordingly, it is a negative latent image.

The electrostatic latent image on the photoconductor 11Y is moved to the position of the developing section 14Y by the rotation of the photoconductor, and the electrostatic latent image is developed there to obtain a primary color toner image of yellow.

The primary color toner image of yellow on the photoconductor is moved to the primary transfer position by the rotation of the photoconductor. At the primary transfer position, the surface of the photoconductor 11Y and the surface of the transfer medium 2Y are brought into contact with each other. Accordingly, the primary color toner image of yellow on the photoconductor undergoes primary transfer to the surface of the transfer medium 2Y.

By the rotation of the transfer medium, the primary color toner image of yellow on the transfer medium 2Y is moved to the position where the primary color toner image of yellow undergoes secondary transfer. At the secondary transfer position, the recording medium R on the conveyor path 4 is sandwiched between the transfer medium 2Y and the support roller 3Y, and the surface of the transfer medium 2Y and the image receptive surface of the recording medium R are brought into contact with each other. Accordingly, the primary color toner image of yellow on the transfer medium 2Y undergoes secondary transfer onto the recording medium R.

Next, in the magenta developing device 1M, the same process as the process of forming the primary color toner image of yellow is executed. That is, in the magenta developing device 1M, a primary color toner image of magenta is formed on the surface of the photoconductor 11M; the formed image undergoes primary transfer to the surface of the transfer medium 2M; and then the transferred image is moved to the position where the primary color toner image of magenta undergoes secondary transfer by the rotation of the transfer medium 2M. Meanwhile, a part having the primary color toner image of yellow formed thereon of the recording medium R is moved from the upstream side of the conveyor path 4 and reaches the position where the primary color toner image of magenta undergoes secondary transfer. The primary color toner image of magenta on the transfer medium 2M is aligned there with the primary color toner image of yellow on the recording medium R and undergoes secondary transfer onto the recording medium R.

Next, in the cyan developing device 1C and the black developing device 1K, the same process as the process of forming the primary color toner image of yellow is executed. Then, the primary color toner images of yellow (Y), magenta (M), cyan (C) and black (K) are overlapped in this order on the recording medium R moved by the conveyor path, thereby obtaining a full-color image including a higher-order color. The recording medium R passes through all of the developing devices, and after the image including the higher-order color is formed, the recording medium R moves to the position where the fixing step is carried out. At that position, the recording medium R is sandwiched between the fixing roller 6 and the support roller 7. Accordingly, the image including the higher-order color is fixed on the recording medium.

### EXAMPLES

Hereinafter, the present disclosure will be described further in detail, with reference to the following examples and comparative examples. However, the present disclosure is not limited to these examples. Herein, part(s) and % are on a mass basis unless otherwise noted.

The weight average molecular weight Mw of the polymer was determined as a polystyrene equivalent molecular weight measured by GPC. A sample for measurement was obtained as follows: a polymer was dissolved in tetrahydrofuran (THF) so as to have a concentration of 2 mg/mL, and an ultrasonic treatment was carried out thereon for 10 minutes, followed by filtration through a 0.45 μm membrane filter, thereby obtaining the sample for measurement. The measurement conditions were as follows: temperature: 40° C., solvent: tetrahydrofuran, flow rate: 1.0 mL/min, concentration: 0.2 wt. %, and sample input amount: 100 μL. As a column, GPC TSKGEL MULTIPORE HXL-M (30 cm×2) manufactured by Tosoh Corporation, was used. Also, the measurement was carried out under the condition that the first-order correlation (Log(Mw)—elution time) in a weight average molecular weight (Mw) range of from 1,000 to 300,000, was 0.98 or more.

### <Magenta Toner>

### Production Example 1: Production of Mixed Crystal of Magenta Pigments

2,5-Di-(4-methylphenylamino) terephthalic acid was cyclized in phosphoric acid to synthesize 2,9-dimethylquinacridone (C.I. Pigment Red 122 (PR122)). Water was added to the obtained phosphoric acid dispersion of 2,9-dimethylquinacridone, and 2,9-dimethylquinacridone was filtered off by a filter and washed with water. Water was added again to the washed 2,9-dimethylquinacridone to obtain an aqueous dispersion having a solid content of 20%.

Similarly, 2,5-di-phenylaminoterephthalic acid was used to produce an aqueous dispersion of quinacridone (C.I. Pigment Violet 19 (PV19)) with a solid content of 20%. To 250 parts of an aqueous dispersion of the dimethylquinacridone (C.I. Pigment Red 122) having a solid content of 20% described above and 250 parts of an aqueous dispersion of the quinacridone (C.I. Pigment Violet 19) having a solid content of 20%, 250 parts of ethanol were added to obtain a mixture liquid of pigments. The mixture was transferred to a container equipped with a cooling tube and allowed to react under heating reflux for 5 hours while the pigments were ground. After completion of the reaction, the pigment was filtered off from the reaction solution, washed, dried and then pulverized to obtain a mixed crystal of magenta pigments (that is, a mixed crystal of C.I. Pigment Red 122 and C.I. Pigment Violet 19). The mass ratio of C.I. Pigment Red 122 to C.I. Pigment Violet 19 contained in the mixed crystal was 1:1.

As a magenta pigment A1, NO. 5500 ST-RED (product name, manufactured by: Daido Chemical Corporation, acid value: 1.71 mgKOH/g) was prepared. The magenta pigment A1 was a magenta pigment A obtained by treating C.I. Pigment Red 48:3 with a rosin acid metal salt, and the content of the rosin acid metal salt when the magenta pigment A was 100 parts by mass, was 5.0 parts by mass.

### Production Example 2: Production of Magenta Pigment A2

First, 20 parts of 4-chloro-6-amino m-sulfonic acid was dispersed in 300 parts of water. Then, 22 parts of 20% hydrochloric acid was added thereto, followed by further addition of ice. While keeping the temperature of the mixture at 0° C., 25.1 parts of a 30% sodium nitrite aqueous solution was added dropwise to the mixture, thereby obtaining a diazonium salt suspension.

Next, 10.2 parts (an amount corresponding to about 5% of the magenta pigment A2) of a potassium salt solution of disproportionated rosin (acid value: 100 mg/KOH) (the content of the disproportionated rosin: 25%) was added to 500 parts of water. While the diluted potassium salt solution of the disproportionated rosin was in a stirring state, an aqueous solution containing 1.82 parts of strontium chloride was added thereto, thereby obtaining a suspension containing a strontium salt of the disproportionated rosin (a suspension A).

Next, 20.6 parts of 2-hydroxy-3-naphthoic acid was dispersed in 380 parts of warm water at 60° C. Then, 20.1 parts of a 48% caustic soda aqueous solution was added thereto, thereby obtaining a coupler solution.

The coupler solution was added to the suspension A to obtain a coupler liquid (a coupler component).

The coupler liquid was cooled to 0° C. While stirring the liquid, the diazonium salt suspension was added thereto in a dropwise manner over 30 minutes. The mixture was stirred for 60 minutes at a temperature of from 0° C. to 3° C. to accomplish a coupling reaction, thereby obtaining a dye suspension.

An aqueous solution obtained by dissolving 20.18 parts of strontium chloride in 90 parts of water, was added to the suspension. The suspension was stirred for 60 minutes to accomplish laking. After the laking reaction was accomplished, the suspension was stirred while heating at 30° C. for 60 minutes, thereby obtaining an aqueous suspension of a strontium lake azo pigment (C.I. Pigment Red 48:3) surface-treated with the strontium salt of the disproportionated rosin. Then, the aqueous suspension was heated to 60° C.; the heated aqueous suspension was stirred for 60 minutes; the pH of the aqueous suspension was adjusted to 7.6 with hydrochloric acid; and then the aqueous suspension was filtered and washed, thereby isolating a wet cake containing the pigment. The isolated wet cake was dried to obtain a magenta pigment A2 (acid value: 0.66 mgKOH/g, the content of the rosin acid metal salt contained in 100 parts by mass of the magenta pigment A2: 5.0 parts by mass).

C.I. Pigment Red 48:3 was prepared as a magenta pigment B. C.I. Pigment Red 269 was prepared as a magenta pigment C.

### Production Example 3: Production of Polar Resin P1

First, 200 parts of toluene v put in a reaction container. While stirring the toluene, the gas inside the reaction container was sufficiently replaced with nitrogen. Then, the temperature of the toluene was increased to 90° C. Then, a mixed solution of 97.0 parts of methyl methacrylate, 2.6 parts of ethyl acrylate, 0.4 parts of acrylic acid, and 3 parts of t-butylperoxy-2-ethylhexanoate (product name: PERBUTYL O, manufactured by NOF Corporation) was added dropwise to the reaction container for two hours. Also, the condition of the mixture was maintained for 10 hours under toluene flux, thereby completing polymerization. Then, the solvent was removed by distillation under reduced pressure, thereby obtaining a polar resin P1 (MMA/EA/AA). The polar resin P1 had an acid value of 2.5 mgKOH/g, a Tg of 74° C., and a Mw of 12600.

### Production Example 4: Production of CCR-A1

A copolymer (CCR-A1) was produced by copolymerizing a total of 92 parts of styrene and n-butyl acrylate with 8 parts of N, N-diethyl-N-methyl-2-(methacryloyloxy)ethylammonium p-toluenesulfonate. In the CCR-A1, the copolymerization ratio of a quaternary ammonium salt group-containing monomer was 8% by mass.

### Production Example 5: Production of CCR—B1

A copolymer (CCR—B1) was produced by copolymerizing a total of 98 parts of styrene and n-butyl acrylate with 2 parts of N, N-diethyl-N-methyl-2-(methacryloyloxy)ethylammonium p-toluenesulfonate. In the CCR—B1, the copolymerization ratio of a quaternary ammonium salt group-containing monomer was 2% by mass.

### [Production of Magenta Toner M-1]

### (1) Preparation of Polymerizable Monomer Composition for Core

First, 74 parts of styrene, 26 parts of n-butyl acrylate and 0.74 parts of divinylbenzene as polymerizable monomers, 1.0 part of tetraethylthiuram disulfide as a molecular weight modifier, and 2.8 parts of the mixed crystal obtained in Production Example 1 (the mixed crystal of C.I. Pigment Red 122 and C.I. Pigment Violet 19) and 4.2 parts of a magenta pigment A1 (product name: NO. 5500 ST-RED, manufactured by: Daido Chemical Corporation, pigment classification: C.I. Pigment Red 48:3, the content of rosin acid metal salt (Sr salt) with respect to 100 parts of the magenta pigment A1: 5.0 parts) as magenta colorants, were wet-pulverized by means of a media-type disperser (product name: PICOMILL, manufactured by: ASADA IRON WORKS. Co., Ltd.)

To the mixture obtained by the wet pulverization, 2.0 parts of the above-described CCR-A1 (the copolymerization ratio of the quaternary ammonium salt group-containing monomer: 8%) and 1.0 part of the above-described CCR—B1 (the copolymerization ratio of the quaternary ammonium salt group-containing monomer: 2%) as charge control resins and 2.0 parts of an ester wax 1 (compound name: hexaglycerin octabehenate, molecular weight: 2649) and 7.0 parts of an ester wax 3 (compound name: pentaerythritol tetrapalmitate, molecular weight: 1088) as softening agents were added, mixed and dissolved to prepare a polymerizable monomer composition for core.

### (2) Preparation of Aqueous Dispersion Medium

An aqueous solution in which 9.9 parts of sodium hydroxide was dissolved in 50 parts of deionized water, was gradually added under stirring to an aqueous solution in which 14.1 parts of magnesium chloride was dissolved in 280 parts of deionized water, thereby preparing a magnesium hydroxide colloidal dispersion.

### (3) Preparation of Polymerizable Monomer for Shell

An aqueous dispersion of a polymerizable monomer for shell was prepared by finely dispersing 2 parts of methyl methacrylate and 130 parts of water by means of an ultrasonic emulsifier.

### (4) Droplets Forming Step

The polymerizable monomer composition for core was added to the magnesium hydroxide colloidal dispersion (the magnesium hydroxide amount: 7.2 parts), and the mixture was further stirred. Then, as a polymerization initiator, 4.4 parts of t-butylperoxy-2-ethylhexanoate was added thereto. The dispersion mixed with the polymerization initiator was dispersed at a rotational frequency of 15,000 rpm by an in-line type emulsifying and dispersing machine (product name: MILDER, manufactured by: Pacific Machinery & Engineering Co., Ltd.) to form droplets of the polymerizable monomer composition for core.

### (5) Polymerization Step

The dispersion containing the droplets of the polymerizable monomer composition for core was placed in a reactor, and the temperature of the dispersion was raised to 90° C. to initiate a polymerization reaction. After reaching the polymerization conversion rate of almost 100%, a solution prepared by dissolving, as a polymerization initiator for shell, 0.1 parts of 2,2′-azobis [2-methyl-N-(2-hydroxyethyl)-propionamide] (product name: VA-086, manufactured by: Wako Pure Chemical Industries, Ltd., a water-soluble initiator) in the aqueous dispersion of the polymerizable monomer for shell, was added to the reactor. Next, the polymerization reaction was further continued by maintaining the dispersion temperature at 95° C. for 4 hours. Then, the polymerization reaction was stopped by water cooling, thereby obtaining an aqueous dispersion of core-shell type colored resin particles.

### (6) Washing, Filtering and Dehydrating Step

The aqueous dispersion of the colored resin particles was subjected to acid washing (25° C., 10 minutes) by adding, while stirring the aqueous dispersion, sulfuric acid to the dispersion until the pH of the dispersion reached 6.0 or less. Then, the colored resin particles were separated by filtration and washed with water. The washing water was filtered. The electric conductivity of the filtrate at this time was 20 μS/cm. The colored resin particles subjected to the washing and filtering steps were dehydrated and dried to obtain the colored resin particles in a dry state.

### (7) External Addition Treatment Step

To 100 parts of the colored resin particles, the following particles were added.
Inorganic fine particles A (hydrophobized silica fine particles having an average particle diameter of 50 nm): 1.26 parts
Inorganic fine particles B (hydrophobized silica fine particles having an average particle diameter of 22 nm): 1.0 part
Inorganic fine particle C (hydrophobized silica fine particles having an average particle diameter of 7 nm): 0.2 parts

They were mixed by use of a high-speed stirring machine (product t name: FM MIXER, manufactured by: Nippon Coke & Engineering Co., Ltd.), thereby preparing a magenta toner M-1.

### [Production of Magenta Toners M-2 to M-4]

Magenta toners M-2 to M-4 were obtained in the same manner as the method for producing the magenta toner M-1, except that in “Preparation of polymerizable monomer composition for core”, the types of the colorants were changed according to Table 1.

### [Production of Magenta Toner M-5]

A magenta toner M-5 was obtained in the same manner as the method for producing the magenta toner M-1, except that in “Preparation of polymerizable monomer composition for core”, 1.0 part of a polymethacrylic acid ester macromonomer (product name: AA-6, manufactured by: Toagosei Chemical Industry Co., Ltd., Tg=94° C.) was further added as a polymerizable monomer; the CCR—B1 was not added; and the types of the colorants were changed according to Table 1.

### [Production of Magenta Toner M-6]

A magenta toner M-6 was obtained in the same manner as the method for producing the magenta toner M-1, except that in “Preparation of polymerizable monomer composition for core”, the CCR—B1 was not added; 1.0 part of the polar resin P1 obtained in Production Example 3 was further added when adding the CCR-A1; and the types of the colorants were changed according to Table 1.

### [Production of Magenta Toner M-7]

A magenta toner M-7 was obtained in the same manner as the method for producing the magenta toner M-1, except that in “Preparation of polymerizable monomer composition for core”, the types of the colorants were changed according to Table 1; the ester waxes 1 and 3 were not used; and 9.0 parts of an ester wax 2 (compound name: pentaerythritol tetrastearate, molecular weight: 1200) was used.

### [Production of Magenta Toner M-8]

A magenta toner M-8 was obtained in the same manner as the method for producing the magenta toner M-1, except that in “Preparation of polymerizable monomer composition for core”, the amount of the added CCR-A1 was changed according to Table 1; the CCR—B1 was not added; the ester wax 1 was not added; and the amount of the added ester wax 3 was changed according to Table 1.

### [Production of Magenta Toner M-9]

A magenta toner M-9 was obtained in the same manner as the method for producing the magenta toner M-1, except that in “Preparation of polymerizable monomer composition for core”, the type and amount of the colorant were changed according to Table 1.

### [Production of Magenta Toner M-10]

A magenta toner M-10 was obtained in the same manner as the method for producing the magenta toner M-1, except that in “Preparation of polymerizable monomer composition for core”, the ester waxes 1 and 3 were not used, and 9.0 parts of an ester wax 4 (compound name: behenyl stearate, molecular weight: 592) was used.

### [Production of Magenta Toner M-11]

A magenta toner M-11 was obtained in the same manner as the method for producing the magenta toner M-1, except that in “Preparation of polymerizable monomer composition for core”, the amount of the added divinylbenzene was changed according to Table 1, and the ester wax 1, the CCR-A1 and the CCR—B1 were not added.

### [Production of Magenta Toner M-12]

A magenta toner M-12 was obtained in the same manner as the method for producing the magenta toner M-1, except that in “Preparation of polymerizable monomer composition for core”, the CCR—B1 was not added, and the type and amount of the colorant were changed according to Table 1.

### [Evaluation of the Magenta Toners]

### 1. Measurement of the Particle Diameter of Each Toner (MULTISIZER)

The volume average particle diameter (Dv) of each toner was measured by use of a particle size distribution measuring device (product name: MULTISIZER, manufactured by: Beckman Coulter, Inc.) This measurement with MULTISIZER was carried out in the following conditions.
Aperture diameter: 100 μm
Dispersion medium: ISOTON II (product name)
Concentration: 10%
Number of the measured hollow particles: 100,000

More specifically, 0.2 g of the toner sample was put in a beaker. As a dispersant, a surfactant aqueous solution (product name: DRIWEL, manufactured by Fujifilm Corporation) was added thereto. In addition, 2 mL of the dispersion medium was added to wet the toner. Then, 10 mL of the dispersion medium was added thereto. The mixture was dispersed for one minute with an ultrasonic disperser. Then, the measurement with the above-described particle size distribution measuring device was carried out.

### 2. Coarse Powder Amount

The coarse powder amount of the toners was measured with a particle size distribution measuring device (product name: MULTISIZER, manufactured by: Beckman Coulter, Inc.) The measurement with the MULTISIZER was carried out by the same conditions and steps of the above-described measurement of the diameter of the toner particles; the volume-based particle size distribution was measured; and the percentage (% by volume) of the particles having a particle diameter of 20 μm or more was measured from the obtained particle size distribution and determined as the coarse powder amount.

### 3. Image Density

The toner was put in a commercially-available, non-magnetic one-component development printer. In an environment at a temperature of 23° C. and a humidity of 50% RH, a 50 mm×50 mm square solid pattern was printed on a sheet of copying paper. At this time, a developing amount M/A, which is the amount of the toner on the copying paper sheet, was changed by changing a developing bias voltage. An unfixed image was removed from the printer, and the toner developed on the sheet was blown off by air. Then, the developing amount M/A was calculated by the following formula.

$$M / A ( mg / {cm}^{2} ) = ( {W}_{1} - {W}_{2} ) / 25 {cm}^{2}$$

W₁: The weight (mg) of the copying paper sheet before the toner was blown off.
W₂: The weight (mg) of the copying paper sheet after the toner was blown off.

The image density of the fixed image of the 5 mm×5 mm square solid pattern which had a M/A of 0.35 mg/cm², was measured with a reflection densitometer (product name: exact, manufactured by: X-Rite Inc.)

### 4. Ultrafine Particle (UFP) Generation Temperature

A predetermined amount of the toner was heated on a heater placed in a chamber. The ultrafine particles emitted into the chamber were continuously measured with a particle counter (model: CPC3007, manufactured by: TSI). Next, the temperature of the heater was increased from 160° C., and the total count of the ultrafine particles having a particle diameter in a range of from 10 nm to 1,000 nm, which were observed during the measurement, was read in increments of 5° C. The temperature at which the total count exceeded 10,000 particles was determined as the emission onset temperature (ultrafine particle (UFP) generation temperature) of the toner.

### 5. Viscoelasticity Measurement

For each color toner, the temperature dependence curve for the loss tangent (tanδ) was obtained by dynamic viscoelasticity measurement. From the obtained temperature-tanδ curve, the loss tangent tanδ (100° C.) of the toner at 100° C. was obtained.

The dynamic viscoelasticity measurement was carried out using a rotating flat plate rheometer (product name: ARES-G2, manufactured by: TA Instruments Inc.) and a cross-hatch plate under the conditions mentioned below. A test piece was produced by pouring 0.2 g of the toner into a cylindrical mold of 8 mm φ and pressurizing the toner at 1.0 MPa for 30 seconds, thereby forming a columnar molded body having a diameter of 8 mm φ and a thickness of 3 mm.

### (Conditions of the Dynamic Viscoelasticity Measurement)

Frequency: 24 Hz
Sample set: A test piece (3 mm thick) was sandwiched between 8 mm φ plates with a 20 g load; the test piece was fused to a jig by increasing the temperature to 80° C.; the temperature was returned to 45° C.; then, increasing the temperature (temperature increase) was started.
Temperature increase rate: 5° C./min
Temperature range: 45° C. to 190° C.

The measurement and evaluation results of the magenta toners M-1 to M-12 are shown in Table 1, along with the toner compositions.

In the following Table 1, “PR122” denotes C.I. Pigment Red 122, and “PV19” denotes C.I. Pigment Violet 19.

TABLE 1

| Toner No. | | M-1 | M-2 | M-3 | M-4 | M-5 | M-6 | M-7 |
|---|---|---|---|---|---|---|---|---|
| Polymerizable | Styrene (parts) | 74 | 74 | 74 | 74 | 74 | 74 | 74 |
| monomer | n-Butyl acrylate (parts) | 26 | 26 | 26 | 26 | 26 | 26 | 26 |
| | Divinylbenzene (parts) | 0.74 | 0.74 | 0.74 | 0.74 | 0.74 | 0.74 | 0.74 |
| | Macromonomer (AA-6) (parts) | | | | | 1.0 | | |
| Molecular weight | TET (parts) | 1.0 | 1.0 | 1.0 | 1.0 | 1.0 | 1.0 | 1.0 |
| modifier | | | | | | | | |
| Softening agent | Ester wax 1 (Mw2649) (parts) | 2.0 | 2.0 | 2.0 | 2.0 | 2.0 | 2.0 | |
| | Ester wax 2 (Mw1200) (parts) | | | | | | | 9.0 |
| | Ester wax 3 (Mw1088) (parts) | 7.0 | 7.0 | 7.0 | 7.0 | 7.0 | 7.0 | |
| | Ester wax 4 (Mw592) (parts) | | | | | | | |
| Charge control | CCR-A1 (Functional group | 2.0 | 2.0 | 2.0 | 2.0 | 2.0 | 2.0 | 2.0 |
| agent | amount 8%) (parts) | | | | | | | |
| | CCR-B1 (Functional group | 1.0 | 1.0 | 1.0 | 1.0 | | | 1.0 |
| | amount 2%) (parts) | | | | | | | |
| Polar resin | Polar resin P1 (parts) | | | | | | 1.0 | |
| Colorant | Mixed crystal of | 2.8 | 2.8 | 2.8 | 2.8 | 2.8 | 2.8 | 2.8 |
| | PR122 and PV19 (parts) | | | | | | | |
| | Magenta pigment A1 (parts) | 4.2 | | | | | | |
| | Magenta pigment A2 (parts) | | | 4.2 | | | | |
| | Magenta pigment B (parts) | | 4.2 | | | | | |
| | Magenta pigment C (parts) | | | | 4.2 | 4.2 | 4.2 | 4.2 |
| Toner evaluation | Toner particle diameter (μm) | 8.5 | 8.5 | 7.9 | 8.8 | 8.2 | 8.2 | 8.2 |
| | Coarse powder amount | 0.2 | 0.2 | 0.3 | 0.2 | 0.2 | 0.1 | 0.2 |
| | (% by volume) | | | | | | | |
| | Image density | 0.81 | 0.82 | 0.80 | 0.79 | 0.76 | 0.78 | 0.80 |
| | Ultrafine particle (UFP) | 195 | 195 | 190 | 190 | 190 | 195 | 185 |
| | generation temperature (° C.) | | | | | | | |
| | tanδ (100° C.) | 0.919 | 0.916 | 0.918 | 0.874 | 0.915 | 0.859 | 0.915 |

| Toner No. | | M-8 | M-9 | M-10 | M-11 | M-12 |
|---|---|---|---|---|---|---|
| Polymerizable | Styrene (parts) | 74 | 74 | 74 | 74 | 74 |
| monomer | n-Butyl acrylate (parts) | 26 | 26 | 26 | 26 | 26 |
| | Divinylbenzene (parts) | 0.74 | 0.74 | 0.74 | 0.20 | 0.74 |
| | Macromonomer (AA-6) (parts) | | | | | |
| Molecular weight | TET (parts) | 1.0 | 1.0 | 1.0 | 1.0 | 1.0 |
| modifier | | | | | | |
| Softening agent | Ester wax 1 (Mw2649) (parts) | | 2.0 | | | 2.0 |
| | Ester wax 2 (Mw1200) (parts) | | | | | |
| | Ester wax 3 (Mw1088) (parts) | 9.0 | 7.0 | | 7.0 | 7.0 |
| | Ester wax 4 (Mw592) (parts) | | | 9.0 | | |
| Charge control | CCR-A1 (Functional group | 1.0 | 2.0 | 2.0 | | 2.0 |
| agent | amount 8%) (parts) | | | | | |
| | CCR-B1 (Functional group | | 1.0 | 1.0 | | |
| | amount 2%) (parts) | | | | | |
| Polar resin | Polar resin P1 (parts) | | | | | |
| Colorant | Mixed crystal of | 2.8 | | 2.8 | 2.8 | |
| | PR122 and PV19 (parts) | | | | | |
| | Magenta pigment A1 (parts) | 4.2 | 7.0 | 4.2 | 4.2 | 7.0 |
| | Magenta pigment A2 (parts) | | | | | |
| | Magenta pigment B (parts) | | | | | |
| | Magenta pigment C (parts) | | | | | |
| Toner evaluation | Toner particle diameter (μm) | 8.5 | 8.5 | 8.1 | 7.9 | 8.7 |
| | Coarse powder amount | 0.9 | 10 | 0.2 | 0.2 | 11 |
| | (% by volume) | | | | | |
| | Image density | 0.65 | 0.75 | 0.82 | 0.70 | 0.60 |
| | Ultrafine particle (UFP) | 180 | 190 | 150 | 190 | 190 |
| | generation temperature (° C.) | | | | | |
| | tanδ (100° C.) | 0.920 | 0.951 | 0.930 | 1.423 | 0.951 |

In the magenta toners M-1 to M-4, M-7 and M-9, the generation of UFP was suppressed, and they were high in image density, since each of the magenta toners M-1 to M-4, M-7 and M-9 contained the ester wax having a molecular weight of from 600 to 3000 as the softening agent and the combination of the copolymers A and B having different functional group amounts as the charge control agent.

It was revealed that the magenta toners M-1 to M-4, M-7 and M-9 had a high UFP generation temperature and suppressed the UFP generation, compared to the magenta toner M-10 which contained the ester wax having a molecular weight of less than 600 as a softening agent.

It was revealed that the image density of the magenta toners M-1 to M-4 and M-7 which contained the quinacridone-based pigment as a colorant, improved compared to the magenta toners M-5, M-6, M-8 and M-11 which similarly contained the quinacridone-based pigment as a colorant, since the magenta toners M-1 to M-4 and M-7 contained the combination of the copolymers A and B as charge control agents.

It was revealed that the image density of the magenta toner M-9 which contained only the magenta pigment A as a colorant, improved compared to the magenta toner M-12 which similarly contained only the magenta pigment A as a colorant, since the magenta toner M-9 contained the combination of the copolymers A and B as charge control agents.

In addition, since the magenta toners M-1 to M-4 and M-7 contained the combination of the quinacridone-based pigment and the quinacridone skeleton-free pigment as colorants, compared to the magenta toners M-9 and M-12 which did not contain a quinacridone-based pigment, the magenta toners M-1 to M-4 and M-7 had a small coarse powder amount, and the generation of coarse particles was suppressed in them.

The magenta toners M-1 to M-9, M-11 and M-12 were applicable to the toner set of the present disclosure, since each of them contained the ester wax having a molecular weight of from 600 to 3000 as the softening agent, and had a tanδ (100° C.) of 0.840 or more. The tanδ (100° C.) of the magenta toner M-6 was relatively low, since it contained the polar resin.

### <Yellow and Cyan Toners>

### [Production of Yellow Toner Y-1]

### 1. Production of Colored Resin Particles

### (1) Preparation of Polymerizable Monomer Composition for Core

First, 72 parts of styrene, 28 parts of n-butyl acrylate, 0.1 parts of a polymethacrylic acid ester macromonomer (product name: AA-6; manufactured by: TOAGOSEI Co., Ltd.; Tg: 94° C.) and 0.71 parts of divinylbenzene as polymerizable monomers, 1.25 parts of tetraethyl thiuram disulfide as a molecular weight modifier, and 7.0 parts of C.I. Pigment Yellow 155 (product name: TONER YELLOW 3GP CT, manufactured by: Clariant) as a colorant, were wet-pulverized by means of a media-type disperser (product name: PICOMILL, manufactured by: ASADA IRON WORKS. Co., Ltd.)

To the mixture obtained by the wet pulverization, 0.8 parts of the above-described CCR-A1 (the copolymerization ratio of the quaternary ammonium salt group-containing monomer: 88) as a charge control resin and 6.0 parts of the ester wax 2 (compound name: pentaerythritol tetrastearate, molecular weight: 1200) as a softening agent were added, mixed and dissolved to prepare a polymerizable monomer composition for core.

### (2) Preparation of Aqueous Dispersion Medium

An aqueous solution in which 7.3 parts of sodium hydroxide was dissolved in 50 parts of deionized water, was gradually added under stirring to an aqueous solution in which 10.4 parts of magnesium chloride was dissolved in 280 parts of deionized water, thereby preparing a magnesium hydroxide colloidal dispersion.

### (3) Preparation of Polymerizable Monomer for Shell

An aqueous dispersion of a polymerizable monomer for shell was prepared by finely dispersing 2 parts of methyl methacrylate and 130 parts of water by means of an ultrasonic emulsifier.

### (4) Droplets Forming Step

The polymerizable monomer composition for core was added to the magnesium hydroxide colloidal dispersion (the magnesium hydroxide amount: 5.3 parts), and the mixture was further stirred. Then, as a polymerization initiator, 6 parts of t-butylperoxy-2-ethylbutanoate was added thereto. The dispersion mixed with the polymerization initiator was dispersed at a rotational frequency of 15,000 rpm by an in-line type emulsifying and dispersing machine (product name: MILDER, manufactured by: Pacific Machinery & Engineering Co., Ltd.) to form droplets of the polymerizable monomer composition for core.

### (5) Polymerization Step

The dispersion containing the droplets of the polymerizable monomer composition for core was placed in a reactor, and the temperature of the dispersion was raised to 90° C. to initiate a polymerization reaction. After reaching the polymerization conversion rate of almost 100%, a solution prepared by dissolving, as a polymerization initiator for shell, 0.1 parts of 2,2′-azobis [2-methyl-N-(2-hydroxyethyl)-propionamide] (product name: VA-086, manufactured by: Wako Pure Chemical Industries, Ltd., a water-soluble initiator) in the aqueous dispersion of the polymerizable monomer for shell, was added to the reactor. Next, the polymerization reaction was further continued by maintaining the dispersion temperature at 95° C. for 4 hours. Then, the polymerization reaction was stopped by water cooling, thereby obtaining an aqueous dispersion of core-shell type colored resin particles.

### (6) Washing, Filtering and Dehydrating Steps

The aqueous dispersion of the colored resin particles was subjected to acid washing (25° C., 10 minutes) by adding, while stirring the aqueous dispersion, sulfuric acid to the dispersion until the pH of the dispersion reached 4.5 or less. Then, the colored resin particles were separated by filtration and washed with water. The washing water was filtered. The electric conductivity of the filtrate at this time was 20 μs/cm. The colored resin particles subjected to the washing and filtering were dehydrated to obtain the colored resin particles in a wet state.

### (7) External Addition Treatment Step

To 100 parts of the colored resin particles, 0.20 parts of hydrophobized silica fine particles having a number average primary particle diameter of 7 nm (product name: TG-820F, manufactured by: Cabot Corporation) were added as the inorganic fine particles C. Then, the colored resin particles were put in a mixing device (product name: LABOMIXER, model: LV-1, manufactured by: Hosokawa Micron Corporation) placed in a constant temperature and humidity room in an environment at 35° C. While mixing the particles at 180 rpm, they were dried for 24 hours, thereby obtaining intermediate particles.

To the intermediate particles, the following particles were added.

Inorganic fine particles A: 1.33 parts of hydrophobized silica fine particles having a number average primary particle diameter of 50 nm (product name: H05TA, manufactured by: Clariant Corporation)

Inorganic fine particles B: 0.53 parts of hydrophobized silica fine particles having a number average primary particle diameter of 20 nm (product name: TG-7120, manufactured by: Cabot Corporation)

Inorganic fine particles C: 0.20 parts of hydrophobized silica fine particles having a number average primary particle diameter of 7 nm (product name: TG-820F, manufactured by: Cabot Corporation)

Organic fine particles D: 0.13 parts of fatty acid metal salt particles having a number average primary particle diameter of 0.5 μm (product name: SPZ-100F, zinc stearate particles manufactured by: Sakai Chemical Industry Co., Ltd.)

They were mixed by means of a high-speed stirring machine (product name: FM MIXER, manufactured by: Nippon Coke Engineering Co., Ltd.) in the following conditions, thereby preparing a yellow toner Y-1.

Peripheral speed of the stirring blades: 46.6 m/s

External addition treatment time: 8.0 min

### [Production of Yellow Toners Y-2 and Y-7]

Yellow toners Y-2 and Y-7 were obtained in the same manner as the method for producing the yellow toner Y-1, except that in “External addition treatment step”, the type or amount of the added organic fine particles D was changed according to Table 2.

SPX-100F, which was used in the production of the yellow toner Y-7, is fatty acid metal salt particles having a number average primary particle diameter of 0.72 μm (product name: SPX-100F, magnesium stearate particles manufactured by: Sakai Chemical Industry Co., Ltd.)

### [Production of Yellow Toners Y-3 to Y-6]

Yellow toners Y-3 to Y-6 were obtained in the same manner as the method for producing the yellow toner Y-1, except that in “Preparation of polymerizable monomer composition for core”, the amount of the added divinylbenzene was changed according to Table 2; moreover, in “External addition treatment step” of the production of the yellow toners Y-4 to Y-6, the amount of the added organic fine particles D was changed according to Table 2.

### [Production of Yellow Toner Y-8]

A yellow toner Y-8 was obtained in the same manner as the method for producing the yellow toner Y-1, except that in “Preparation of polymerizable monomer composition for core”, the amounts of the added polymerizable monomers and the amount of the added colorant were changed according to Table 2, and the CCR-A1 was not added; moreover, in “External addition treatment step”, the organic fine particles D were not added.

### [Production of Cyan Toner C-1]

A cyan toner C-1 was obtained in the same manner as the method for producing the yellow toner Y-1, except that in “Preparation of polymerizable monomer composition for core”, instead of 6.0 parts the ester wax 2, 5.0 parts of the ester wax 1 (compound name: hexaglycerin octabehenate, molecular weight: 2649) was used as a softening agent, and instead of 7.0 parts of C.I. Pigment Yellow 155 (PY155), 7.0 parts of C.I. Pigment Blue 15:3 (PB15: 3) was used as a colorant.

### [Production of Cyan Toner C-2]

A cyan toner C-2 was obtained in the same manner as the method for producing the cyan toner C-1, except that in “Preparation of polymerizable monomer composition for core”, instead of 5.0 parts the ester wax 1, 7.0 parts of the ester wax 2 (compound name: pentaerythritol tetrastearate, molecular weight: 1200) was used as a softening agent, and in “External addition treatment step”, the organic fine particles D were not added.

### [Evaluation of Yellow and Cyan Toners]

In the same manner as the magenta toners, the particle diameter, UFP generation temperature and viscoelasticity of the yellow and cyan toners were measured. The measurement results of the yellow toners Y-1 to Y-8 and the cyan toners C-1 and C-2 are shown in Table 2, along with the toner compositions.

TABLE 2

| Toner No. | | Y-1 | Y-2 | Y-3 | Y-4 | Y-5 | Y-6 | Y-7 | Y-8 | C-1 | C-2 |
|---|---|---|---|---|---|---|---|---|---|---|---|
| Polymerizable | Styrene (parts) | 72 | 72 | 72 | 72 | 72 | 72 | 72 | 70 | 72 | 72 |
| monomer | n-Butyl acrylate (parts) | 28 | 28 | 28 | 28 | 28 | 28 | 28 | 30 | 28 | 28 |
| | Divinylbenzene (parts) | 0.71 | 0.71 | 0.69 | 0.69 | 0.69 | 0.69 | 0.71 | 0.72 | 0.71 | 0.71 |
| | Macromonomer (AA-6) (parts) | 0.1 | 0.1 | 0.1 | 0.1 | 0.1 | 0.1 | 0.1 | 0.1 | 0.1 | 0.1 |
| Molecular | TET (parts) | 1.25 | 1.25 | 1.25 | 1.25 | 1.25 | 1.25 | 1.25 | 1.25 | 1.25 | 1.25 |
| weight modifier | | | | | | | | | | | |
| Softening agent | Ester wax 1 (Mw2649) (parts) | | | | | | | | | 5.0 | |
| | Ester wax 2 (Mw1200) (parts) | 6.0 | 6.0 | 6.0 | 6.0 | 6.0 | 6.0 | 6.0 | 6.0 | | 7.0 |
| | Ester wax 3 (Mw1088) (parts) | | | | | | | | | | |
| | Ester wax 4 (Mw592) (parts) | | | | | | | | | | |
| Charge control | CCR-A1 (Functional group | 0.80 | 0.80 | 0.80 | 0.80 | 0.80 | 0.80 | 0.80 | | 0.80 | 0.80 |
| agent | amount 8%) (parts) | | | | | | | | | | |
| Colorant | PY155 (parts) | 7.0 | 7.0 | 7.0 | 7.0 | 7.0 | 7.0 | 7.0 | 8.0 | | |
| | PB15:3 (parts) | | | | | | | | | 7.0 | 7.0 |
| Organic fine | SPZ-100F (parts) | 0.13 | 0.05 | 0.13 | 0.04 | 0.09 | 0.14 | | | 0.13 | |
| particles D | SPX-100F (parts) | | | | | | | 0.13 | | | |
| Toner | Toner particle diameter (μm) | 7.0 | 7.0 | 7.1 | 7.1 | 7.1 | 7.0 | 7.0 | 8.0 | 7.0 | 6.8 |
| evaluation | Ultrafine particle (UFP) | 185 | 185 | 185 | 185 | 185 | 185 | 185 | 175 | 195 | 190 |
| | generation temperature (° C.) | | | | | | | | | | |
| | tanδ (100° C.) | 0.843 | 0.853 | 0.917 | 0.918 | 0.905 | 0.945 | 0.855 | 1.060 | 0.916 | 0.925 |

Since each of the yellow toners Y-1 to Y-8 and the cyan toners C-1 and C-2 contained the ester wax having a molecular weight of from 600 to 3000 as the softening agent, they were toners in which the UFP generation was suppressed.

Also, each of the yellow toners Y-1 to Y-8 and the cyan toners C-1 and C-2 had a tanδ (100° C.) of 0.840 or more.

### <Toner Set>

### Examples 1 to 7 and Comparative Examples 1 to 3

According to Table 3, the initial color toner was combined with a different color toner. Accordingly, the toner sets of Examples 1 to 7 and Comparative Examples 1 to 3 were obtained.

Table 3 shows, for each of the toner sets, the absolute value of the difference between the tanδ (100° C.) of the initial color toner and that of the different color toner.

### [Peeling Evaluation]

A commercially-available, non-magnetic one-component developing printer (printing speed: 20 sheets/min) was modified such that the temperature of the fixing roller was changeable. Printing sheets were set in the printer. According to Table 3, a developing device containing the initial color toner and another developing device containing the different color toner were set in the printer. Solid pattern printing of a secondary color at a printing density of 100% was carried out by overprinting so as to form, on a transfer paper, a 5 cm×20 cm rectangle at a position 0.5 cm away from the leading edge of the paper. While the temperature of the fixing roller of the printer was changed by 5° C. from 200° C. to 150° C., solid pattern printing of a secondary color was similarly carried out to visually confirm whether peeling of the toner layers from the paper surface, peeling between the overprinted toner layers, or peeling occurring within the toner layer(s) occurred or not. The temperature of the fixing roller at the time when peeling occurred during the solid pattern printing, was determined as the peeling occurrence temperature.

The evaluation was made based on the following three criteria: A, B and F. It can be evaluated that the fixation of the toner layers improves as the peeling occurrence temperature decreases. Accordingly, A is superior in the fixation of the toner layers to B, and F is failure. The evaluation results are shown in Table 3.

### <Evaluation Criteria>

A: The peeling occurrence temperature was 160° C. or less.
B: The peeling occurrence temperature was more than 160° C. and 170° C. or less.
F: The peeling occurrence temperature was more than 170° C.

TABLE 3

| | | | | | | | | Comparative | Comparative | Comparative |
|---|---|---|---|---|---|---|---|---|---|---|
| | Example 1 | Example 2 | Example 3 | Example 4 | Example 5 | Example 6 | Example 7 | Example 1 | Example 2 | Example 3 |
| Initial color toner | M-1 | M-2 | M-9 | M-1 | M-1 | Y-1 | Y-2 | M-1 | M-11 | Y-8 |
| Different color toner | Y-1 | Y-1 | Y-1 | C-1 | C-2 | C-1 | C-1 | Y-8 | Y-1 | C-1 |
| \|tanδ (M, 100° C.) − | 0.076 | 0.073 | 0.108 | | | | | 0.141 | 0.580 | |
| tanδ (Y, 100° C.)\| | | | | | | | | | | |
| \|tanδ (M, 100° C.) − | | | | 0.032 | 0.006 | | | | | |
| tanδ (C, 100° C.)\| | | | | | | | | | | |
| \|tanδ (Y, 100° C.) − | | | | | | 0.073 | 0.063 | | | 0.144 |
| tanδ (C, 100° C.)\| | | | | | | | | | | |
| Peeling evaluation | A | A | B | A | A | A | A | F | F | F |

As for the toner sets of Examples 1 to 7, the absolute value of the difference between the tanδ (100° C.) of the initial color toner and that of the different color toner was 0.140 or less. Accordingly, during the overprinting, the peeling occurrence temperature was low, that is, the peeling of the toner layer(s) was suppressed. Especially, as for the toner sets of Examples 1, 2 and 4 to 7, since the absolute value of the difference between the tanδ (100° C.) of the initial color toner and that of the different color toner was 0.100 or less, the peeling of the toner layer(s) was particularly suppressed.

From the results of the peeling evaluation of Examples 1 to 7, it was revealed that the peeling of the toner layers from the paper surface, the peeling between the toner layers, and the peeling occurring within the toner layer(s) were suppressed when the difference in tanδ (100° C.) between the t toners used to overprint the secondary color was 0.140 or less. The above-described peeling evaluation is the result of overprinting the secondary color. However, as for the toner set of the present disclosure which satisfy the formulae (I), (II) and (III), by overprinting with the yellow, magenta and cyan toners, the difference in tanδ (100° C.) between the overprinted toners was 0.140 or less. Accordingly, it is clear that even in the case of overprinting a higher-order color of tertiary color or higher, peeling of the toner layer of the initial color from the paper surface is suppressed, and peeling between the toner layers printed thereafter and peeling occurring within the toner layer(s) are suppressed.

Meanwhile, as for the toner sets of Comparative Examples 1 to 3, the absolute value of the difference between the tanδ (100° C.) of the initial color toner and that of the different color toner was more than 0.140. Accordingly, during the overprinting, the peeling occurrence temperature was high, that is, the peeling of the toner layer(s) was likely to occur.

### REFERENCE SIGNS LIST

100. Image forming device
R. Recording medium
D. Conveying direction
1. Developing device (1Y, 1M, 1C, 1K)
2. Transfer medium (2Y, 2M, 2C, 2K)
3. Support roller (3Y, 3M, 3C, 3K)
4. Conveyor path
5. Exposure device
6. Fixing roller
7. Support roller
11. Photoconductor (11Y, 11M, 11C, 11K)
12. Charging roller (12Y, 12M, 12C, 12K)
13. Laser light irradiator (13Y, 13M, 13C, 13K)
14. Developing section (14Y, 14M, 14C, 14K)
15. Cleaner (15Y, 15M, 15C, 15K)
16. Toner storage (16Y, 16M, 16C, 16K)

1. A toner set comprising color toners each comprising colored resin particles, which contain a binder resin, a colorant, a softening agent and a charge control agent, and an external additive,
wherein the color toners comprise at least a yellow toner, a magenta toner and a cyan toner;
wherein each of the yellow, magenta and cyan toners comprises, as the softening agent, an ester wax having a molecular weight of from 600 to 3000; and
wherein a loss tangent of the yellow toner at 100° C. (tanδ (Y, 100° C.)), a loss tangent of the magenta toner at 100° C. (tanδ (M, 100° C.)) and a loss tangent of the cyan toner at 100° C. (tanδ (C, 100° C.)), each of which is specified from a temperature dependence curve of the loss tangent (tanδ) of the toner obtained by dynamic viscoelasticity measurement at a measurement frequency of 24 Hz, are all 0.840 or more and satisfy the following formulae (I), (II) and (III):
$$\vert tan δ ( M , 100 ° C . ) - tan δ ( Y , 100 ° C . ) \vert \leq 0.14 \qquad ( I )$$
$$\vert tan δ ( M , 100 ° C . ) - tan δ ( C , 100 ° C . ) \vert \leq 0.14 \qquad ( II )$$
$$\vert tan δ ( Y , 100 ° C . ) - tan δ ( C , 100 ° C . ) \vert \leq 0.14 . \qquad ( III )$$

2. The toner set according to claim 1, wherein the magenta toner comprises, as the charge control agent, copolymers A and B each comprising a functional group-containing monomer unit; a content of the functional group-containing monomer unit in the copolymer A is larger than a content of the functional group-containing monomer unit in the copolymer B; and the functional group contained in the copolymer A and the functional group contained in the copolymer B are the same and are quaternary ammonium groups or quaternary ammonium salt-containing groups.

3. The toner set according to claim 1, wherein the magenta toner comprises, as the colorant, a quinacridone skeleton-containing pigment.

4. The toner set according to claim 3, wherein the magenta toner further comprises, as the colorant, a quinacridone skeleton-free pigment.

5. An image forming method using the toner set defined by claim 1.

6. A magenta toner comprising colored resin particles, which contain a binder resin, a colorant, a softening agent and a charge control agent, and an external additive,
wherein the softening agent comprises an ester wax having a molecular weight of from 600 to 3000;
wherein the charge control agent comprises copolymers A and B each comprising a functional group-containing monomer unit; a content of the functional group-containing monomer unit in the copolymer A is larger than a content of the functional group-containing monomer unit in the copolymer B; and the functional group contained in the copolymer A and the functional group contained in the copolymer B are the same and are quaternary ammonium groups or quaternary ammonium salt-containing groups; and
wherein a loss tangent of the magenta toner at 100° C. (tanδ (M, 100° C.)), which is specified from a temperature dependence curve of the loss tangent (tanδ) of the toner obtained by dynamic viscoelasticity measurement at a measurement frequency of 24 Hz, is 0.840 or more.

7. The magenta toner according to claim 6, wherein the colorant comprises a quinacridone skeleton-containing pigment.
